(19) United States
(12) Patent Application Publication
(10) Pub. No.: US 2015/0235240 A1
(43) Pub. Date: Aug. 20, 2015

(54) METHOD AND APPARATUS FOR IMPROVING CUSTOMER INTERACTION EXPERIENCES

(71) Applicant: 24/7 CUSTOMER, INC., Campbell, CA (US)

(72) Inventors: Andrew Liang Ping CHANG, Palo Alto, CA (US); Pallipuram V. KANNAN, Saratoga, CA (US); Ravi VIJAYARAGHAVAN, Bangalore (IN); Brian KISSEL, Menlo Park, CA (US)

(21) Appl. No.: 14/625,381

(22) Filed: Feb. 18, 2015

Related U.S. Application Data
(60) Provisional application No. 61/941,399, filed on Feb. 18, 2014.
(60) Provisional application No. 62/000,992, filed on May 20, 2014.

(51) Int. Cl. G06Q 30/02; H04M 3/493; H04M 3/51; G06Q 30/00

(52) U.S. Cl. CPC G06Q 30/0202; G06Q 30/016; H04M 3/493; H04M 3/5183; H04M 3/5166

(57) ABSTRACT

A computer-implemented method and an apparatus for improving customer interaction experiences determines one or more personas associated with a customer based on customer activity on a plurality of interaction channels. One or more persona profiles corresponding to the one or more personas are generated and maintained, where a persona profile is representative of a set of behavioral traits exhibited substantially consistently by the customer when inhabiting a persona. One or more customer interactions are correlated to at least one persona based on the one or more persona profiles, where the one or more customer interactions are conducted over one or more interaction channels. An intention of the customer is predicted based on the correlation of the one or more customer interactions to the at least one persona.

### CROSS REFERENCE TO RELATED APPLICATIONS

This application claims priority to U.S. provisional patent application Ser. No. 61/941,399, filed Feb. 18, 2014, and U.S. provisional patent application Ser. No. 62/000,992, filed May 20, 2014, each of which is incorporated herein in its entirety by this reference thereto.

### TECHNICAL FIELD

The invention relates to customer relation management. More particularly, the invention relates to a method and apparatus for improving customer interaction experiences.

### BACKGROUND

Enterprises, nowadays, offer a multitude of interaction channels to existing/potential customers (hereinafter referred to as ‘customers’) for facilitating customer interactions. For example, the enterprises provide a website or a web portal, i.e. a web channel, to enable the customers to locate products/services of interest, to receive information about the products/services, to make payments, to lodge complaints, and the like. In another illustrative example, the enterprises may offer dedicated customer sales and service representatives, such as for example live agents, to interact with the customers by engaging in voice conversations, i.e. speech channel, and/or chat conversations, i.e. chat channel. Similarly, the enterprises may offer other interaction channels such as an interactive voice response (IVR) channel, a social channel, and the like.

The customer interactions on the interaction channels may assume various forms. For example, a customer may choose a self-service option to conduct a customer interaction, for example through an IVR channel.

In another example scenario, the customer may choose to seek assistance from a live agent to conduct a customer interaction.

In yet another example scenario, some customer interactions may assume the form of assisted self-service option, i.e. a customer interaction involving a combination of self-service and live agents. For example, if the customer is browsing on a website, has a query, and chooses to seek an answer to that query through a Frequently Asked Questions (FAQ) section on the website, a chat widget may be provisioned to the customer on the FAQ webpage to assist the customer with the answer to the query. Alternatively, the customer could choose to switch interaction channels, for example from the web channel to the speech channel, call for assistance over the phone, and interact with either or both an IVR system and a live agent.

In another example, a customer may attempt self-service using a native mobile application and then choose to switch to, or continue with, a full web site.

In another example, a customer may have filled a web form partially and requires agent assistance to complete the remaining form fields of the web form. In such cases, the customer interaction may assume the form of assisted self-service, which can occur in one interaction channel or across multiple interaction channels. Accordingly, the customer interactions may be conducted over a multitude of interaction channels and may assume various forms.

The enterprises, typically, seek to predict the intention of each customer accessing the interaction channels because prediction of the customer's intentions enables the enterprises to make suitable recommendations to the customers and thus enhance a customer service experience and/or improve the chances of making a sale. To predict a customer's intention accurately and provide treatment to the customer, customer interactions across a plurality of interaction channels may need to be correlated to the same customer. However, correlating customer interactions across channels to the same customer may be complicated because the customer may exhibit different behavioral traits based on a variety of circumstances. For example, in some scenarios, a customer may exhibit different interaction styles even within interactions with the same enterprise based on different factors, such as the importance or severity of the issue or the nature or cost of a purchase or the customer mood, time pressure at the moment of interaction, and the like. As a result of such variance in behavioral traits exhibited by the customer, it is difficult to correlate customer interactions across interaction channels to the same customer, thereby posing difficulties in predicting intention accurately and providing personalized recommendations to the customer.

### SUMMARY

In an embodiment of the invention, a computer-implemented method includes determining, by a processor, one or more personas associated with a customer based on customer activity on a plurality of interaction channels. One or more persona profiles corresponding to the one or more personas are generated and maintained by the processor, where a persona profile from among the one or more persona profiles is representative of a set of behavioral traits exhibited substantially consistently by the customer when inhabiting a persona from among the one or more personas. The method correlates, by the processor, one or more customer interactions to at least one persona from among the one or more personas based on the one or more persona profiles, where the one or more customer interactions are conducted over one or more interaction channels from among the plurality of interaction channels. An intention of the customer is predicted by the processor based on the correlation of the one or more customer interactions to the at least one persona.

In another embodiment of the invention, the method for improving customer interaction experiences includes determining, by a processor, one or more personas associated with a customer based on customer activity on a plurality of interaction channels. A presence of at least one persona from among the one or more personas is identified in one or more interaction channels from among the plurality of interaction channels by the processor. The presence of the at least one persona in the one or more interaction channels is stored as presence information. The method determines, by the processor, attention information corresponding to the customer if the at least one persona of the customer is identified to be present in two or more interaction channels from among the plurality of interaction channels. The attention information is indicative of current attention of the customer. A notification is provided to the customer, by the processor, on an interaction channel from among the plurality of interaction channels, where the customer is identified to be active or most likely to be active based on the presence information and the attention information.

In another embodiment of the invention, an apparatus for improving customer interaction experiences comprises at least one processor and a memory. The memory stores machine executable instructions therein, that when executed by the at least one processor, cause the apparatus to determine one or more personas associated with a customer based on customer activity on a plurality of interaction channels. The apparatus generates and maintains one or more persona profiles corresponding to the one or more personas. A persona profile from among the one or more persona profiles is representative of a set of behavioral traits exhibited substantially consistently by the customer when inhabiting a persona from among the one or more personas. The apparatus correlates one or more customer interactions to at least one persona from among the one or more personas based on the one or more persona profiles, where the one or more customer interactions are conducted over one or more interaction channels from among the plurality of interaction channels. The apparatus predicts the intention of the customer based on the correlation of the one or more customer interactions to the at least one persona.

In another embodiment of the invention, a non-transitory computer-readable medium storing a set of instructions that when executed cause a computer to perform a method for improving customer interaction experiences is disclosed. The method executed by the computer determines one or more personas associated with a customer based on customer activity on a plurality of interaction channels. One or more persona profiles corresponding to the one or more personas are generated and maintained, where a persona profile from among the one or more persona profiles is representative of a set of behavioral traits exhibited substantially consistently by the customer when inhabiting a persona from among the one or more personas. The method correlates one or more customer interactions to at least one persona from among the one or more personas based on the one or more persona profiles, where the one or more customer interactions are conducted over one or more interaction channels from among the plurality of interaction channels. An intention of the customer is predicted based on the correlation of the one or more customer interactions to the at least one persona.

### BRIEF DESCRIPTION OF THE FIGURES

FIG. 1 is a schematic diagram showing an illustrative environment in accordance with an example scenario;

FIG. 2 is a block diagram of an example apparatus for improving customer interaction experiences in accordance with an embodiment of the invention;

FIG. 3 shows an example architectural implementation of the apparatus of FIG. 2 in accordance with an embodiment of the invention;

FIG. 4 shows a schematic representation of an exemplary scenario for illustrating a provisioning of personalized treatment to a customer by the apparatus of FIG. 2 based on correlation of a persona to a customer interaction in accordance with an embodiment of the invention;

FIG. 5 shows another schematic representation of an exemplary scenario for illustrating a provisioning of personalized treatment to a customer by the apparatus of FIG. 2 in accordance with another embodiment of the invention;

FIG. 6 illustrates a flow diagram of a first example method for improving customer interaction experiences in accordance with an embodiment of the invention;

FIG. 7 illustrates a flow diagram of a second example method for improving customer interaction experiences in accordance with an embodiment of the invention; and

FIGS. 8A and 8B illustrate a flow diagram of a third example method for improving customer interaction experiences in accordance with an embodiment of the invention.

### DETAILED DESCRIPTION

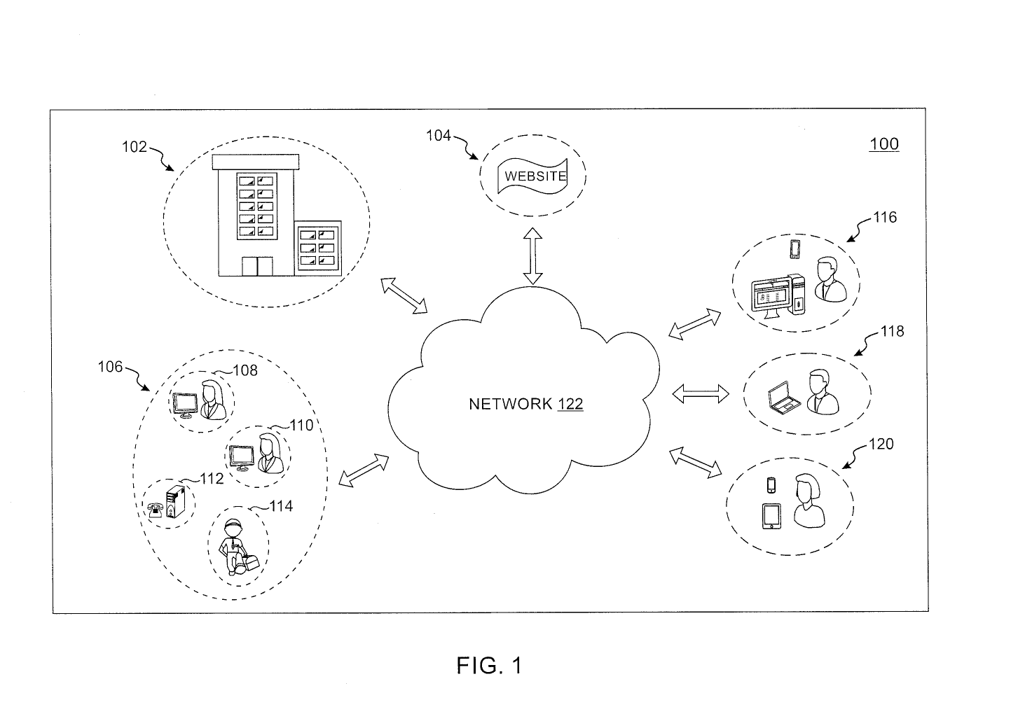

FIG. 1 is a schematic diagram showing an illustrative environment 100 in accordance with an example scenario. The environment 100 depicts an example enterprise 102. Though the enterprise 102 is exemplarily depicted to be a firm, it is understood that the enterprise 102 may be any large or small entity (for example, a corporation, a small business or even a brick and mortar entity) offering products and/or services to existing and prospective users (referred to herein as customers). Enterprises, such as the enterprise 102, offer a multitude of interaction channels to customers for facilitating customer interactions. For example, enterprises provide a website or a web portal (i.e. a web channel) to enable the customers to locate products/services of interest, to receive information about the products/services, to make payments, to lodge complaints and the like. In another illustrative example, enterprises offer virtual agents to interact with the customer and enable self-service. In another illustrative example, the enterprises offer dedicated customer sales and service representatives, such as live agents, to interact with the customers by engaging in voice conversations (i.e. speech channel) and/or chat conversations (i.e. chat channel). Similarly, the enterprises offer other interaction channels such as an interactive voice response (IVR) channel, a social channel and the like. In the environment 100, the enterprise 102 is depicted to be associated with a website 104 (or a web portal) and a dedicated customer support facility 106 including human resources and machine-based resources for facilitating customer interactions. The customer support facility 106 is exemplarily depicted to include two live agents 108 and 110 (who provide customers with voice-based assistance and chat-based/online assistance, respectively), an automated voice response system, such as IVR system 112 and a direct sales/service personnel 114. It is understood that the customer support facility 106 may also include automated chat agents such as chat bots, and other web or digital self-assist mechanisms. Moreover, it is noted that customer support facility 106 is depicted to include only two live agents 108 and 110, the IVR system 112 and the direct sales/service personnel 114 for illustration purposes and it is understood that the customer support facility 106 may include fewer or more number of resources than those depicted in FIG. 1.

The environment 100 further depicts a plurality of customers, such as a customer 116, a customer 118 and a customer 120. It is noted that the term ‘customers’ as used herein includes both existing customers as well as potential customers of information, products and services offered by the enterprise 102. Further, it is understood that three customers are depicted herein for example purposes and that the enterprise 102 may be associated with many such customers. In some example scenarios, the customers 116, 118 and 120 may interact with the website 104 and/or the resources deployed at the customer support facility 106 over a network 122 using their respective electronic devices. Examples of such electronic devices may include mobile phones, Smartphones, laptops, personal computers, tablet computers, personal digital assistants, Smart watches, web-enabled wearable devices and the like. Examples of the network 122 may include wired networks, wireless networks or a combination thereof. Examples of wired networks may include Ethernet, local area network (LAN), fiber-optic cable network and the like. Examples of wireless networks may include cellular networks like GSM/3G/4G/CDMA based networks, wireless LAN, Bluetooth or Zigbee networks and the like. An example of a combination of wired and wireless networks may include the Internet.

As explained above, customer interactions with the enterprise 102 are carried out over a multitude of interaction channels. In some example scenarios, such interactions can be sequential, concurrent or partially overlapping. Further, such customer interactions assume various forms. For example, a customer may choose a self-service option to conduct a customer interaction (for example, through an IVR channel). In another example scenario, the customer may choose to seek assistance from a live agent or a chatbot to conduct a customer interaction. In yet another example scenario, some customer interactions may assume the form of assisted self-service option, i.e. a customer interaction involving a combination of self-service and live agents. Accordingly, the customer interactions may be conducted over a multitude of interaction channels and may assume various forms.

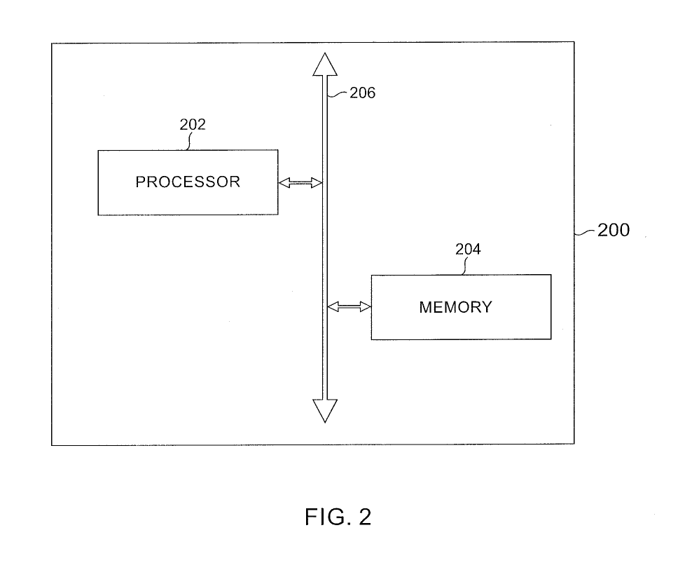

The enterprises, typically, seek to predict intention of each customer accessing the interaction channels as prediction of the customer's intentions enables the enterprises to either make suitable recommendations to the customer in order to enhance a customer service experience and/or improve chances of a sale, or, create and complete an action for or transaction with the customer. In order to accurately predict intention and provide treatment to a customer, customer interactions across a plurality of channels may need to be correlated to the same customer. However, correlating customer interactions across interaction channels to the same customer may be complicated as a customer may be capable of exhibiting different behavioral traits based on a variety of circumstances. For example, even within the interactions between a customer and the same enterprise, the customer may exhibit different interaction styles based on different factors such as the importance/severity of the issue or the nature or cost of a purchase or customer's mood and/or time pressure at the moment of interaction. In another illustrative example, a customer may exhibit behavioral traits of a bargain shopper when at a discount store, whereas the same customer may buy a suit at a premium-clothing store as a high net-worth individual would. In another illustrative example, a customer may prefer air-travel with a particular airline when traveling for professional commitments, whereas the same customer may prefer another airline when traveling with family. As a result of such variance in the behavioral traits exhibited by the customer, it is difficult to correlate customer interactions across interaction channels to the same customer, thereby posing difficulties in predicting intentions accurately and providing personalized recommendations to the customer. Various embodiments of the present invention provide methods and apparatuses that are capable of overcoming these and other obstacles and providing additional benefits. More specifically, methods and apparatuses disclosed herein enable automatic correlation of interactions in different concurrent and/or sequential channels (for example, web channel, speech channel, native mobile channel, social channel, agent channel and branch channel) to the same customer and combine real-time correlation information, intention prediction and personalized action across interaction channels to provide the easiest and quickest appropriate resolution for customer issues, thereby improving customer interaction experiences. An apparatus for improving customer interaction experiences is explained with reference to FIG. 2.

FIG. 2 is a block diagram of an example apparatus 200 for improving customer interaction experiences in accordance with an embodiment. In an embodiment, the apparatus 200 may be embodied as a web server communicably associated with one or more enterprise web portals/websites, such as the website 104 of FIG. 1, and the customer support center, such as the customer support facility 106 associated with the enterprise 102. Pursuant to an exemplary scenario, the apparatus 200 may be any machine capable of executing a set of instructions (sequential and/or otherwise) so as to improve customer interaction experiences.

The apparatus 200 includes at least one processor, such as the processor 202 and a memory 204. It is noted that though the apparatus 200 is depicted to include only one processor, the apparatus 200 may include more number of processors therein. In an embodiment, the processor 202 and the memory 204 are configured to communicate with each other via or through a bus 206. Examples of the bus 206 may include, but are not limited to, a data bus, an address bus, a control bus, and the like. The bus 206 may be, for example, a serial bus, a bi-directional bus or a unidirectional bus. In an embodiment, the bus 206 may be embodied as a centralized circuit system.

In an embodiment, the memory 204 is capable of storing machine executable instructions. Further, the processor 202 is capable of executing the stored machine executable instructions. In an embodiment, the processor 202 may be embodied as a multi-core processor, a single core processor, or a combination of one or more multi-core processors and one or more single core processors. For example, the processor 202 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. In an embodiment, the processor 202 may be configured to execute hard-coded functionality. In an embodiment, the processor 202 is embodied as an executor of software instructions, wherein the instructions may specifically configure the processor 202 to perform the algorithms and/or operations described herein when the instructions are executed. The processor 202 may include, among other things, a clock, an arithmetic logic unit (ALU) and logic gates configured to support an operation of the processor 202. The memory 204 may be embodied as one or more volatile memory devices, one or more non-volatile memory devices, and/or a combination of one or more volatile memory devices and non-volatile memory devices. For example, the memory 204 may be embodied as magnetic storage devices (such as hard disk drives, floppy disks, magnetic tapes, etc.), optical magnetic storage devices (e.g. magneto-optical disks), CD-ROM (compact disc read only memory), CD-R (compact disc recordable), CD-R/W (compact disc rewritable), DVD (Digital Versatile Disc), BD (Blu-ray® Disc), and semiconductor memories (such as mask ROM, PROM (programmable ROM), EPROM (erasable PROM), flash ROM, RAM (random access memory), etc.).

In an embodiment, the processor 202 is configured to, with the content of the memory 204, cause the apparatus 200 to determine one or more personas associated with a customer based on customer activity on a plurality of interaction channels. As explained with reference to FIG. 1, customers may interact with an enterprise over multiple interaction channels. The information related to the customer activity on the interaction channels may be collated and stored in the memory 204 as interaction data. For example, the customer may access a website corresponding to an enterprise for locating content of interest. Accordingly, information related to customer activity on the website, such as sequence of web pages visited, menus accessed on one or more web pages, time spent on the web pages and such other information related to the customer's web journey may be stored as interaction data. In another illustrative example, if the customer has contacted a customer service center associated with the enterprise and interacted with an IVR system, then the customer's intention (referred to as ‘intent’ hereinafter) for contacting the IVR system, the IVR options selected by the customer, whether the customer's concern was resolved or not and such other information related to customer activity on the IVR channel may be stored as interaction data. It is understood that interaction data may further include data collated from customer activity on other interaction channels, such as speech channel, chat channel, social media channel, native mobile application channel, enterprise branch channel (for example, customer's visit to a physical store) and the like.

In addition to the interaction data, the memory 204 is configured to store profile information corresponding to the customer. The stored profile information may include customer's name, contact details, personal and family information, financial information, information relating to products and services associated with the customer, social media account information, other related messaging or sharing platforms and the like. The customer information may further include information related to customer interests and preferences. In some exemplary embodiments, the customer information may also include calendar information associated with the customer. For example, the calendar information may include information related to an availability of the customer during the duration of the day/week/month.

The apparatus 200 is caused to analyze the interaction data and the profile information to identify behavioral traits exhibited by the customer during various interaction scenarios and accordingly determine one or more personas associated with the customer. For example, the customer may assume a persona of a bargain shopper when at a discount store, whereas the same customer may assume a persona of a high net-worth individual when buying a suit at a premium clothing store. In another example scenario, a customer may exhibit markedly different risk preferences in their own accounts, such as accounts related to a retirement fund, a holiday savings fund and an education savings investment. In some example scenarios, the customer may exhibit different interaction styles even within interactions with the same enterprise based on different factors, such as the importance or severity of the issue or the nature or cost of a purchase or customer's mood, time pressure at the moment of interaction and the like. Accordingly, the apparatus 200 is caused to identify one or more such personas (for example, a bargain hunter, risk averse investor etc.) associated with the customer based on the customer activity on the interaction channels. More specifically, the apparatus 200 is caused to identify the one or more such personas associated with the customer based on extracting behavioral traits exhibited by the customer during the customer activity on the plurality of interaction channels.

In an embodiment, the processor 202 is configured to, with the content of the memory 204, cause the apparatus 200 to generate and maintain one or more persona profiles corresponding to the one or more personas, where each persona profile is representative of a set of behavioral traits exhibited substantially consistently by the customer when inhabiting a persona. In an embodiment, the set of behavioral traits comprise behavioral traits related to at least one of customer preference, likely actions of the customer and likely needs of the customer. For example, the apparatus 200 may generate and maintain a persona profile corresponding to the bargain hunter persona of the customer. The preferences, likely actions and likely needs of the customer when inhabiting the bargain hunter persona may be determined and stored as set of behavioral traits in the persona profile corresponding to the bargain hunter persona. Similarly, the apparatus 200 may be caused to generate and maintain a persona profile corresponding to the premium store visitor persona of the customer and so on and so forth. The persona profiles corresponding to the multiple persona profiles may be maintained by the apparatus 200 to enable prediction of the most effective treatment for the customer while he/she is embodying the specific persona.

In an embodiment, one or more behavioral traits from among the set of behavioral traits are shared among the one or more personas. More specifically, certain preferences may be common across multiple persona profiles for a customer. For example, the customer may exhibit a preference for web channel or preference to use mobile phone, or preference for self-service or even a preference/need for reassurance/confirmation during the course of the interaction. Such preferences may be common to customer's multiple persona profiles. Other preferences, however, such as risk tolerance or openness to types of offers may be applicable to a specific customer persona. For example, a customer's acceptance of offer to invest in emerging markets investment option may differ depending on whether the customer is accessing their primary investment fund or their child's college education fund. It is noted that each persona profile may be associated with multiple journeys (for example, possible courses of action during a customer interaction) and intents. In an embodiment, the apparatus 200 is caused to generate an aggregate profile corresponding to the customer based on the one or more persona profiles. More specifically, the apparatus 200 is caused to combine information related to the multiple persona profiles into an aggregate profile to develop a comprehensive view of the customer.

In an embodiment, the processor 202 is configured to, with the content of the memory 204, cause the apparatus 200 to correlate one or more customer interactions to at least one persona based on the one or more persona profiles, where the one or more customer interactions may be conducted over one or more interaction channels. In an embodiment, in order to facilitate correlation of the one or more customer interactions to the at least one persona, the apparatus 200 is caused to identify a presence of the at least one persona in the one or more interaction channels. In an embodiment, a presence of the customer in an interaction channel is determined first and thereafter checked for the persona present therein. The determination of the presence of the customer in an interaction channel may be performed as explained below:

In an embodiment, the apparatus 200 may be configured to actively probe a presence of the customer in any of the interaction channels. For example, the apparatus 200 may be caused to track invoking of native mobile applications corresponding to a chosen product/service in electronic devices corresponding to the customers. Upon identifying an instance of invoking of a native mobile application in an electronic device associated with a customer, the apparatus 200 may be caused to determine the presence of the customer in the native channel. In another illustrative example, if the apparatus 200 identifies an instance of a customer browsing a website corresponding to the selected product/service, then the apparatus 200 may be caused to determine the presence of the customer in the web channel. In yet another illustrative example, the customer may have logged in to one or more social networking media accounts or public interaction/sharing accounts, such as for example, in any of Facebook™, Twitter™, LinkedIn™ and the like. The apparatus 200 may accordingly record the presence of the customer in social channel. In still another illustrative example, the customer may be chatting on a chat application. The apparatus 200 may detect the presence of the customer in the messaging channel and record the presence accordingly. In an embodiment, one or more tracking cookies may be configured to be included in a device browser associated with the customer device, which may enable the apparatus 200 to identify the presence of the customer in an interaction channel. It is understood that determining presence of the customer in an interaction channel may be performed by the apparatus 200 based on stored data corresponding to the customer. As explained above, the profile information may include personal details, such as name, mailing address, contact information such as mobile phone number, login id, IP address and the like. Accordingly, an instance of invoking a native mobile application in a mobile phone may result in determination of the customer associated with the corresponding mobile phone number to be present in the native channel. In another illustrative example, an instance of browsing of a website corresponding to the product/service may result in determination of the customer associated with the corresponding login information/IP address to be present in the web channel. Once the presence of the customer in an interaction channel is identified, then, the correlation of the corresponding customer interaction to a persona profile is performed based on the stored multiple persona profiles. More specifically, one or more behavioral traits, or identification traits, exhibited by the customer in the current/on-going interaction may be identified and compared with sets of behavioral or identification traits included within the multiple persona profiles to determine the presence of the persona in the interaction channel. If the customer is matched to an existing persona profile then the unique key for that profile is incorporated into the current interaction log for that customer. The current/on-going customer interaction may thereafter be linked to the persona present therein to facilitate the said correlation and given the persona's unique key. If the presence of the persona is detected in multiple interaction channels, then the concurrent or sequential customer interactions may be correlated to the same persona and all these interactions are also given the same unique key. In an embodiment, the presence of a persona in an interaction channel is stored as presence information.

In an embodiment, the processor 202 is configured to, with the content of the memory 204, cause the apparatus 200 to predict intention (also referred to herein as intent) of the customer based on said correlation of the one or more customer interactions to the at least one persona. In addition to interaction data from the current/on-going customer interactions, the apparatus 200 is caused to mine stored information corresponding to the customers and their interactions (i.e. interaction data). The stored information may be subjected to a set of text mining & predictive models (hereinafter collectively referred to as prediction models) for mining relevant information that drive the prediction of the customer intent. Examples of the prediction models may be based on algorithms including, but not limited to algorithms such as Logistic regression, Naïve Bayesian, Rule Engines, neural networks, decision trees, support vector machines, k-nearest neighbor, K-means and the like. The prediction models may also be configured to extract certain features from the customer interactions or from the agent interactions or from both customer and agent interactions. Further, the prediction models may be configured to extract features by utilizing a relationship between the customer and agent interactions (for example, sentiment of the customer for a given agent response). Examples of the features that may be fed into the prediction models may include, but are not limited to, any combinations of words features such as n-grams, unigrams, bigrams and trigrams, word phrases, part-of-speech of words, sentiment of words, sentiment of sentences, position of words, customer keyword searches, customer click data, customer web journeys, the customer interaction history and the like. In an embodiment, the prediction models may utilize any combination of the above-mentioned input features along with the customer interaction data such as, but not limited to, which agent handled the dialogue, what the outcome was, interaction transfers if any and the like to predict the customer's likely intents. The mined information enables the apparatus 200 to infer intents of the customers for being present in the interaction channel.

In an embodiment, the processor 202 is configured to, with the content of the memory 204, cause the apparatus 200 to determine one or more recommendations for providing personalized treatment to the customer based on the predicted intent. In an embodiment, the apparatus 200 is further caused to provide the personalized treatment to the customer during the one or more customer interactions based on the one or more recommendations. In an embodiment, the personalized treatment provided to the customer based on the one or more recommendations is configured to maximally reduce at least one of cognitive effort and activity effort for the customer for achieving the predicted intention. More specifically, the provided recommendation is such that the subsequent personalized treatment provided to the customer creates the lowest cognitive and/or activity effort for the customer to fulfill the customer's identified or predicted intent and journey. In an embodiment, the apparatus 200 is caused to track and update location information (for example, geo-location data) corresponding to the customer, where the location information facilitates said determination of the one or more recommendations. For example, if the customer invokes a native mobile application corresponding to best shopping deals indicating that the persona present in the native channel corresponds to the bargain shopper persona, and, moreover if the location information of customer indicates that the customer is in an enterprise store outlet (i.e. in branch channel), then an intent of the customer for being present in the store may be inferred and one or more recommendations to provide a more personalized treatment to the customer may be determined, such as for example, arranging the outlet supervisor to personally meet the customer and address his/her concerns, recommend related products in the store that the customer may be interested in and that may be bought at a discount and the like.

In an embodiment, providing personalized treatment involves lowering a degree of authentication required or avoiding repetition of actions already performed in concurrent or sequential interactions initiated by the customer subsequent to initiating the one or more customer interactions upon authentication of the customer on the one or more interaction channels. Such provisioning of personalized treatment is further explained with reference to an illustrative example: In an example scenario, the location information captured from a native mobile channel during a customer's use of a mobile application may be matched in the memory 204 against historical address data from the stored customer profile information, which then provides specific reference account number, automatic number identification (ANI) and personal name enabling the apparatus 200 to correlate three concurrent and live presence interactions in mobile, phone and web channels and (1) greet the customer by name in the web channel (2) anticipate and simplify steps required for the customer to authenticate, while (3) simultaneously merging the search words they are using on the web channel, with the screens they clicked through on their mobile application and then predict both the intent of their next phone call and allow them to skip ahead and over steps during that phone call that they have already completed in the other interaction channels. It is understood that such an integration of persona, presence, and intent data to complement across interaction channels, time and events improves a prediction accuracy and effectiveness for the individual customer's intent, best-delivered treatment including most effective interaction channel or interaction channels, likely obstacles, and workarounds and the like.

In an embodiment, the processor 202 is configured to, with the content of the memory 204, cause the apparatus 200 to maintain up-to-date state information corresponding to the customer. In an embodiment, the state information includes attributes indicative of status of the one or more personas, presence information related to detected presence of the one or more personas in the plurality of interaction channels, and predicted intentions for the customer. In some embodiments, the state information includes unique keys used to group personas. For example, an attribute may indicate the status of whether a particular persona was present in a specific interaction channel or not. In another illustrative example, an attribute included within the state information may indicate the status of predicted intent for a current customer interaction (for example, how realistic or probable is the predicted intent). In an embodiment, each attribute is associated with a value and a corresponding confidence factor. The value may be embodied as a binary representation based value or a probability-based value. For example, value of attributes related to persona and presence information may be either confirmed in a binary form, such as ‘yes’ and ‘no’, or probabilistically scored based on the confidence factor. In an illustrative example, the presence of a detected persona in an interaction channel may be either confirmed (for example, “yes”) or denied (“no”) or probabilistically scored (for example, presence of the persona in the interaction channel may be confirmed with 60% probability). A confidence factor may further be associated with such values. For example, a scale including values from 1 to 5 may be devised, where value ‘5’ represents maximum confidence and value ‘1’ represents least confidence. Each attribute value, either scored in a binary manner or probabilistically, may be associated with a number from the scale indicative of the amount of confidence in the value ascribed to the attribute.

In an embodiment, the apparatus 200 is caused to calculate the value and the confidence factor associated with accuracy of the persona by a series of direct and indirect evidence/correlations to facts, parameters and/or other personas that are known and are already confirmed. An example of such a parameter is a time constant parameter, which determines how long retained information is relevant or fresh, after which the information needs to be refreshed. Accordingly, the value for each attribute in the state information is associated with a time constant parameter indicative of an amount of time for which the said value is relevant, and, wherein the value or the corresponding confidence factor is revised upon lapse of the said time. The time constant parameter is further explained below:

As information is updated in the apparatus 200 at different time instances, each intent, journey, presence, persona information of the customer may be associated with a minimum elapsed time. For example, if a customer device is not working, then the customer may be safely predicted to interact with a customer support representative within a day's time. However, if the customer has an issue in a bill and has contacted the agent for resolution, then the customer may not contact the customer support representative again till the next bill is generated, implying the minimum elapsed time of ˜30 days. Accordingly, the information may have different time constants associated therewith and accordingly, the time constant parameter may be factored into determining the confidence factor and probability data. As additional data is discovered for persona and presence of the customer, probability data can be either upgraded or downgraded resulting in changes to specific treatment. In an embodiment, a value of the attribute related to customer presence may be captured, tracked and decided upon for both confirmed personas and probabilistic personas enabling the tracking and treatment of probable but not-yet-confirmed correlated interactions. As explained above, presence in one or more interaction channels simultaneously directly influences the decision on best treatment, likely journey and targeted outcome as defined in rules and models associated with the apparatus 200. In an embodiment, an impact of values of the attributes, the associated confidence factors and time constant parameters on treatment and outcomes may be continuously fed back into the apparatus 200 to facilitate a learning therefrom and further refine detecting presence of new/existing personas, predicting intent and providing recommendations of treatments for customers and recommendations of information to the customers for improving customer interaction experiences and to efficiently complete the customer's journey with the minimum cognitive and activity effort for the customer.

In an embodiment, the processor 202 is configured to, with the content of the memory 204, cause the apparatus 200 to perform continuous scanning of the plurality of interaction channels to retrieve real-time information related to at least one of the one or more personas, one or more new personas, the presence information related to the detected presence of the one or more personas and the predicted intentions corresponding to the one or more personas. In an embodiment, the retrieval of the said information is performed from at least one interaction channel. Further, the state information is updated based on the said information. In an embodiment, the processor 202 is configured to, with the content of the memory 204, cause the apparatus 200 to provide the retrieved information from the at least one channel and the updated state information to one or more remaining interaction channels from among the plurality of interaction channels. More specifically, the apparatus 200 is caused to pull data corresponding to the persona, intent, presence and state information from, or push data into, the plurality of interaction channels.

In an embodiment, the retrieval of the information from the at least one interaction channel and the provisioning of the retrieved information along with the updated state information to the one or more remaining interaction channels is performed based on pre-defined rules. An illustrative example of a rule may include, but is not limited to thresholds defined for confidence factors and probability data based on which a push/pull of persona or presence information may be decided upon. In another illustrative example, a rule may be defined for prioritizing an order of interaction channels in which to search and check for same presence information. In yet another example, a rule may be defined to immediately scan for presence/persona in a voice channel if the same presence/persona is detected in the web channel. In still another example, a rule may be defined to de-prioritize the ‘social’ channel if the presence/persona is detected in the web channel. In an embodiment, the apparatus 200 may be caused to define a time threshold for pulling information from each interaction channel, such as for example, restricting the lookout for persona or presence information to last five days only and the like. Such rules may be observed while pushing/pulling information to/from each interaction channel.

In an embodiment, the processor 202 is configured to, with the content of the memory 204, cause the apparatus 200 to determine attention information corresponding to the customer if the at least one persona is identified to be present in two or more interaction channels, where the attention information is indicative of a current attention of the customer. For example, even though the customer has logged in one or more social media accounts, the customer may be currently browsing a website, then the processor 202 is caused to determine the attention information as the web channel. The processor 202 may be configured to store the presence information as well as the attention information in the memory 204. In an embodiment, the processor 202 is configured to, with the content of the memory 204, cause the apparatus 200 to track and update the presence information and the attention information corresponding to the customer. In an embodiment, the presence information and the attention information may be utilized to determine an interaction channel in which the customer is most active or most likely to be active. In an embodiment, the apparatus 200 is caused to provide a notification to the customer on the interaction channel in which the customer is most active or most likely to be active, based on the persona detected. For example, upon determining that the customer is active on the social channel (for example, based on the determined presence and attention information), the apparatus 200 is caused to provision the notification on the social networking media account of the customer. In an embodiment, the apparatus 200 may be caused to take into consideration a nature of notification content prior to provisioning the notification on the interaction channel on which the customer is active. For example, if the notification corresponds to bill payment information, then the apparatus 200 is caused to provision the request in a personal manner, such as for example by using a chat channel in the social networking media account as opposed to provisioning the request in a public manner in which the notification is visible to other users, for example by posting on the wall of the customer's social networking media account. Alternatively, if the notification corresponds to an attractive offer on a product or a service, then the notification may be posted on the wall of the customer's social networking media account. As explained above, the apparatus 200 is caused to provision the notification on a best interaction channel (i.e. an interaction channel on which the customer is currently active or most likely to be active) associated with the customer based on the persona detected. It is noted that the provisioning of the notification to the customer by the apparatus 200 may not be limited to devices associated with the customer. For example, in an example scenario, if the customer is determined to be currently active (or predicted to be present/attentive) on their smartphone, then the apparatus 200 is caused to provision the notification to the customer on their smartphone screen. For example, in an example scenario, if the customer is determined to be currently active (or predicted to be present/attentive) on their tablet, then the apparatus 200 is caused to provision the notification to the customer on their tablet screen. For example, in an example scenario, if the customer is determined to be currently active (or predicted to be present/attentive) on both their smartphone and their tablet, then the apparatus 200 is caused to provision the notification to the customer on either one or both the smartphone screen and the tablet screen based on the prediction of the best recommended treatment for that customer based on their persona, intent, journey, context, history and the like, which may enable the customer to have the least one of cognitive effort and activity effort moving forward in their journey. For example, in an example scenario, if the customer is determined to be currently active (or predicted to be present/attentive) on an interactive screen in an aircraft based on mined flight/seat information corresponding to the customer, then the apparatus 200 is caused to provision the notification to the customer on the interactive screen. Similarly, the apparatus 200 is caused to provision notifications on interactive screens in shopping centers, offices, banks or any such other public places, where the customer is currently active, and, where such interactive screens can be publicly utilized by other users/customers. Accordingly, the best interaction channel determined/predicted for provisioning notification may include any medium/device currently associated or most likely to be associated with the customer.

In an embodiment, the notification is configured to be responsive to at least one of the customer's preference—as indicated by the identified persona—for a type of content, a presentation of the content, a medium of interaction (for example, device and/or interaction channel preference) and a time for receiving the said notification. In an embodiment, the apparatus 200 is caused to determine the type and the content of notifications to be sent to the customer based on the stored customer information and the inferred intent of the customer. For example, the notification is configured to be a passive notification or an active notification based on pre-determined criteria, where the passive notification is configured to provide useful information to the customer and, where the active notification is configured to prompt the customer to perform an action, complete an action and/or confirm an action that has been completed automatically on the customer's behalf. For example, if the customer is to be notified of payment of a bill, then the apparatus 200 may be caused to configure the type of notification to be a passive notification informing the customer of the bill due date. However, if the bill payment is due for next day, then the apparatus 200 may be caused to configure the notification to be an active notification prompting the customer to take immediate action. For example, the active notification may be configured to include a hyperlink which may direct the customer to a website for paying the bill. Alternatively, the active notification may be configured with clickable widget, which may direct the customer to an agent for enabling the customer to pay the bill. In other illustrative example, if it is inferred that the customer is interested in purchasing a product or availing a service, then the apparatus 200 may be caused to configure an active notification for facilitating an interaction with an agent (for example, a chat interaction or a voice interaction with an IVR system or an agent) for enabling the customer to complete the purchase.

In addition to the type of notification, the apparatus 200 may be caused to configure the content of notifications to generate optimum response from the customer for an identified persona. For example, a notification corresponding to an attractive offer for a product or a service may be complimented with information, such as for example, pictures of friends of customers who also bought the product or availed the service, personal and professional information relating to customer such as for example birthdays, anniversaries, change in professional task's or environment and the like. Similarly, a current location information or the calendar information of the customer may be utilized for generating notification content that is relevant for the customer's current location and schedule.

In an embodiment, the apparatus 200 is caused to predict a time duration for which the customer is expected to be attentive and thereafter configure the presentation of the content to optimize a utilization of time duration for which the customer is predicted to be attentive. More specifically, a design of notification may be configured in a manner that optimizes a utilization of the time duration for which the customer is predicted to be attentive to the notification. Accordingly, a window size color, length of textual content, type of content (for example, video content, image content or textual content) and the like, may be optimally selected by the apparatus 200.

As explained above, the notifications may be one of active notifications and passive notifications. In an embodiment, the active notification may be configured to include a request for interaction with a customer support representative. In an illustrative example, if the customer is browsing a website, then a widget may be provisioned to the customer requesting his/her permission to allow interaction with an agent/IVR system. In another illustrative example, if the customer is accessing a SMS notification or invoking a native mobile application, then a pop-up window displaying a textual request for allowing interaction with an agent/IVR system may be provisioned to the customer in the SMS channel. In another embodiment, the request for interaction may be provisioned while taking into account a customer's historic medium (i.e. device and interaction channel) preferences for customer service interactions. For example, a customer may prefer conducting the interactions over a voice call (i.e. a speech channel preference) whereas another customer may prefer to interact with customer service representatives over chat (i.e. a messaging medium preference). Similarly, customers may have varied device preferences, such as some customers may prefer to be contacted over phone, whereas some may prefer chatting over a personal computer. Accordingly, the notification may suggest conducting the interaction over a particular channel and/or device preferred by the customer. In an illustrative example, if a customer is already active in one interaction channel and is identified in one or more other interaction channels, the active notification can be sent either via the original first interaction channel or to any one or more of the other interaction channels based on a prediction of the most effective, lowest cognitive and activity effort method to engage the customer. In an illustrative example, if a customer has called into the IVR system and is identified present on a tablet the active notification may be provided in the IVR channel directing the customer to accept the notification and with focus to the tablet or the active notification could be provided directly on the tablet or both. In an illustrative example, if the customer has been identified to be active in a messaging channel and if the customer's historical preference for interactions has been identified to be speech channel, then an active notification may be sent on the messaging channel itself including text such as ‘Would you like our customer service representative to call you to discuss your requirements?’ In another illustrative example, if the customer has been identified to be active in the native channel on a tablet device and if the customer's historical preference for interactions has been identified to be the chat channel, then a request for interaction may be sent on the native channel itself including text such as ‘Would you like to chat with our customer service representative to discuss your requirements?’ Accordingly, in some embodiments, the active notifications may also suggest a day/time for scheduling the interaction. The customer may choose to ignore or act on the notification provisioned by the apparatus 200. In an embodiment, the apparatus 200 is caused to receive the customer response (for example, one of an approval for interaction with the agent/IVR system or a ignoring of the notification).

In an embodiment, the apparatus 200 is caused to initiate interaction with the customer upon reception of an approval for interaction from the customer. For example, the apparatus 200 is caused to initiate a voice call conversation between an agent/IVR system and the customer upon learning of the approval of the request for interaction by the customer. In an illustrative example, the apparatus 200 is caused to place a toll free voice call from the agent/IVR system's behalf to the customer to initiate the interaction. In an embodiment, the voice call initiated between the agent/IVR system and the customer may be executed as a natural language conversation. For example, the IVR system may query the customer as to what action or actions the customer wants to perform. In an illustrative example, the IVR system may query the customer by using a phrase such as ‘How may I help you?’ The customer may respond to the query using a natural language response, which may be in any form and use any terms, which are comfortable for the customer. The IVR system may then convert the response into text and use techniques that are based on a special grammar that is trained to identify certain keywords more accurately than others. An example of one such grammar type is that of statistical language models (SLM) which takes into consideration the sequence of words to get the best transcription. In an embodiment, the interaction initiated by the apparatus 200 may be embodied as a chat conversation. In another embodiment, the interaction initiated by the apparatus 200 may be embodied as a web or a digital self-assistance based interaction.

In an embodiment, the customer may initiate the interaction with the agent/IVR system upon receiving the notification from the apparatus 200. In an embodiment, the apparatus 200 is caused to determine the best interaction medium (as well as the customer preferred interaction medium) for conducting the interaction. In an embodiment, the apparatus 200 may suggest diverting the initiated interaction to another interaction medium based on the said determination.

In another embodiment, the apparatus 200 is caused to establish a tie between interaction channels allowing for communication via one interaction channel to be augmented or transferred to another interaction channel that may be more optimal. The alternative interaction channel may contain a different mode of communication. For example, verbal communication in an IVR system can be augmented with pertinent graphical images presented through a Web browser in a coincident Web session. For example, if it is determined that the customer can be better served by using other interaction channels than that with which the customer is concurrently interacting, then the apparatus 200 is caused to offer integrated services to the customer by using both the current interaction channel and the other interaction channels, or it diverts the customer to the other interaction channel from the interaction channel with which customer is concurrently interacting. If the customer is interacting on two interaction channels at once, the apparatus 200 is caused to use multi-channel data to coordinate the experience across the two or more interaction channels. For example, if the product shopper still has a web page open when he makes the call to the IVR system, the IVR system can offer a deal on a particular product model and simultaneously push the web browser to the web page for that product. This is possible because the IVR phone call is from a phone number that is associated with the HTTP cookie for that web browser. In an illustrative example, the apparatus 200 is caused to supplement or divert a customer call to a linked web session. The linked web session may be established by forwarding the corresponding web links or content to the customer via SMS or email, by asking and/or instructing the customer to visit a personalized web page, by opening a preconfigured web page whenever the customer calls a predefined number, by a registered customer device initiating a linked session in response to the request from a customer support representative, or by the customer initiating a session on the customer's device and linking the session. In an embodiment, the web sessions may be automated as well as agent-guided, web sessions. In an embodiment, the apparatus 200 may be caused to authenticate the customer during addition of an interaction channel or where customer is interacting via a device, which can be utilized by other customers. For example, consider a phone call interaction that contains customer authentication. When a mobile web experience is added to this existing phone call, authentication may be achieved by virtue of the phone call continuing along with the web interaction. Further, for security reasons the mobile web experience may last only for the duration of the call. In some embodiments, where the web experience is on a different device than the phone, for example desktop or laptop, authentication may be achieved by sending email with a microsite uniform resource locator (URL) to the registered email on account for the customer. Alternatively, a unique URL may be provided to the customer on the phone call, which may last only for the duration of the phone call. It is understood that other modes of authentication such as bio-metric data, facial/speech recognition and the like may also be utilized for facilitating such linked interaction sessions.

In an embodiment, the apparatus 200 is caused to create, capture, and/or pass unique identifiers between multiple contact channels, such as web, mobile, IVR, phone, automotive, television and the like, to identify and tag the customer and their context, e.g. history, past behavior, steps progressed, obstacles and/or issues encountered, etc., uniquely. In an embodiment, the unique identifiers may be used to create linkages across mediums and devices within the same session, as well as across sessions probabilistically based on machine learning and statistical models driven by behavior and other attributes of customer journeys. Examples of various unique identifiers may include, but are not limited to IP address, user-agent, Web cookies, third party Web cookies, order IDs, request IDs, various Personally identifiable information (PII), mobile device identifiers, and the like. The creating, passing, and matching of unique identifiers to unique customers enables the seamless transfer of context, experience, history, action, information, and identification between the separate interaction mediums that customers typically use to engage with enterprises and/or businesses.

In an embodiment, the apparatus 200 is caused to provision a variety of notifications based on the predicted customer issue, device availability, location and predicted best mode of interaction. As explained, in addition to predicting the intent, the apparatus 200 is configured to predict the best medium of interaction affiliated with the customer. More specifically, the apparatus 200 is caused to predicting the best interaction channel as well as which device the customer is most likely to use for receiving the notification or for interacting with a customer support representative. In an embodiment, the apparatus 200 may be caused to predict the best medium of interaction given the nature of the interaction and the determined persona, presence information and the attention information corresponding to the customer. For example, given the nature of the interaction and the identified persona, if a voice medium is better mode of interaction than the currently preferred chat medium, then the apparatus 200 may suggest the voice medium to facilitate the interaction. As explained above, the apparatus 200 may be caused to determine location information corresponding to the customer. In some example embodiments, the apparatus 200 may be caused to obtain the location of the customer from the customer device, which may, for example, detect the location of the customer using a global positioning system (GPS) or other triangulation techniques and provide such location information to the apparatus 200. The location of the customer may also be determined by a native application that is running on the customer device. The native application may work independently or in coordination with systems operated by the telecommunications provider. Such location information may be utilized for configuring the notifications. For example, if a customer has been identified to have swiped his credit card at a gas station, then it may be deduced that the customer is currently on the street and accordingly may not prefer notifications in certain interaction channels, such as the chat channel. Similarly, if the customer has been identified to be currently at a location remote from the locations typically associated with the customer, then a time zone of the customer's current location may be taken into account while determining the best time and the interaction medium for provisioning the notification.

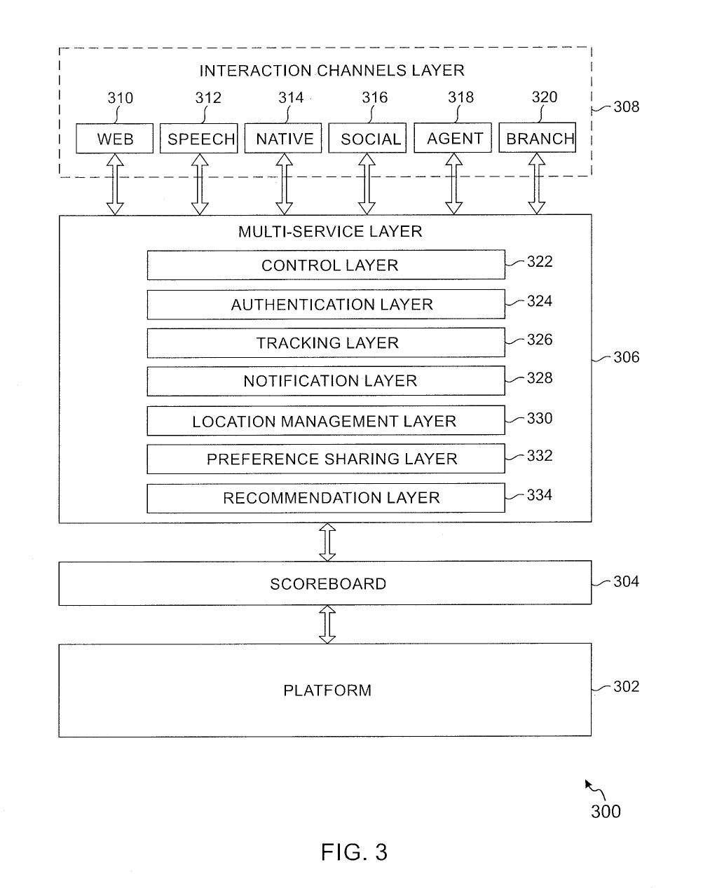

In an embodiment, the various components of the apparatus 200 may be implemented as a fully distributed system across different geographic locations. In an alternate embodiment, the apparatus 200 may be embodied as a monolithic centralized platform. In another embodiment, the apparatus 200 may be embodied as a mix of existing open systems, proprietary systems and third party systems. In another embodiment, the apparatus 200 may be implemented completely as a set of software layers on top of existing hardware systems. One such implementation of the apparatus 200 is explained with reference to FIG. 3.

FIG. 3 shows an example architectural implementation 300 of the apparatus 200 of FIG. 2 in accordance with an embodiment. As suggested in FIG. 2, the apparatus 200 may be implemented completely as a set of software layers on top of existing hardware systems. More specifically, one or more functions attributed to the processor 202 of the apparatus 200 may be executed via one or more software layers in conjunction with a hardware platform. Accordingly, an architectural implementation 300 (referred to hereinafter as implementation 300) of the apparatus 200 is depicted in FIG. 3. The implementation 300 is depicted to include a platform 302, a scoreboard 304, a multi-service layer 306 and an interaction channels layer 308. It is understood that the various components of the architecture, such as the platform 302, the scoreboard 304, the multi-service layer 306 and the interaction channels layer 308 are communicably associated with each other and may be implemented using hardware, software, firmware or any combination thereof.

The interaction channels layer 308 is configured to facilitate a real-time access to customer interactions being conducted over a plurality of interaction channels such as ‘Web’ 310, ‘Speech’ 312, ‘Native’ 314, ‘Social’ 316, ‘Agent’ 318, ‘Branch’ 320 and the like. An example of customer interaction being conducted over the web channel (i.e. ‘Web’ 310) may include, but is not limited to, an online chat conversation between a customer and an agent or a chat bot. An example of a customer interaction being conducted over a speech channel (i.e. ‘Speech’ 312) may include, but is not limited to, a voice call conversation between the customer and an IVR mechanism, such as the IVR system depicted in FIG. 1. An example of customer interaction being conducted over a native channel (i.e. ‘Native’ 314) may include, but is not limited to, a customer interaction with a native mobile application residing in a device associated with the customer. Similarly, the customer interactions being conducted over social networking websites, with agents and at enterprise branch outlets may be accessed using the ‘Social’ 316, the ‘Agent’ 318 and the ‘Branch’ 320 channels, respectively. It is understood that the interaction channels layer 308 may not be limited to the interaction channels depicted in FIG. 3 and that the interaction channels layer 308 may include fewer or more interaction channels than those depicted in FIG. 3. Moreover, it is noted that a customer may conduct interactions concurrently or sequentially in one or more interaction channels.

In an embodiment, the multi-service layer 306 includes a plurality of service layers, which are interaction channel agnostic and which are configured to actively scan the real-time customer interactions and pull data from, or push data into, the plurality of interaction channels. For example, the service layers may be configured to push new persona, presence, intent, state information along with action data acquired from other interaction channels into each interaction channel and pull the same from each interaction channel driven based on pre-defined rules as explained with reference to FIG. 2. The exemplary service layers in the multi-service layer 306 include, but are not limited to, a control layer 322, an authentication layer 324, a tracking layer 326, a notifications layer 328, a location management layer 330, a preference sharing layer 332 and a recommendation layer 334. It is noted that the various layers in the multi-services layer 306 are depicted herein for illustrative purposes only and that the multi-service layer 306 may include more or fewer number of such service layers.

In an embodiment, the control layer 322 is configured to be a supervisory layer responsible for proactive execution of various functionalities being rendered by other service layers. In an embodiment, the control layer 322 is also responsible for controlling a flow/sequence of the said execution. In an embodiment, the authentication layer 324 is configured to manage an authentication/re-authentication of customers across a plurality of interaction channels. For example, if a customer has been recently identified and authenticated in a web channel, and, the customer concurrently calls in on a speech channel, then a degree of authentication required may be modified by the authentication layer 324. Similarly, if the customer has contacted an agent on phone and the customer is concurrently active on the native mobile application, then one or more authentication requirements may be skipped. Accordingly, the authentication layer 324 may be configured to make the authentication/re-authentication easier or harder for a customer based on the detected presence in one or more concurrent interaction channels.

In an embodiment, the tracking layer 326 is configured to continuously monitor, track and collect information related to customer personas, presence, intent and the like. In an embodiment, the notifications layer 328 is configured to determine which channel to notify the customer on, if the customer is detected to be concurrently active on a plurality of interaction channels. For example, if the customer is detected to be concurrently present in a web channel (for example, on a web enabled device like a tablet computer) and on a speech channel (for example, on the mobile phone) while in a vehicle, then the relevant notifications may be pushed to the customer on the speech channel as opposed to the web channel if the persona indicates that the customer is more likely to prefer listening to the information while driving as opposed to viewing the information on the web enabled device. In an embodiment, the location management layer 330 is configured to track and update location information corresponding to the customer. The location information may be retrieved from a variety of sources, such as customer interaction on a native mobile application, a GPS enabled functionality on a customer web enabled device and the like. In an embodiment, the preference sharing layer 332 is configured to share customer preferences across the plurality of interaction channels. For example, if it is observed that a customer seeks reassurance/confirmation during customer interactions on one or more interaction channels, and then such a preference may be shared by tying the preference to the customer persona for subsequent use in customer interactions in same or other interaction channels. In an embodiment, the recommendation layer 334 is configured to predict the best specific treatment (for example, form of treatment, user experience or preference of channel/channels) for a customer issue for a particular persona.

In an embodiment, a tracking of cross-channel persona, presence and parameter data for push/pull of information by the plurality of service layers may be managed through the scoreboard 304. As explained with reference to FIG. 2, state information corresponding to the customer is maintained, where the state information includes attributes indicative of status of the one or more personas, presence information related to detected presence of the one or more personas in the plurality of interaction channels, and predicted intentions for the customer. In some embodiments, the state information also includes unique keys used to group personas. Moreover, each attribute is associated with a value and a corresponding confidence factor. Further, the value is also associated with a time constant parameter indicative of an amount of time for which the said value is relevant, and, wherein the value or the corresponding confidence factor is revised upon lapse of the said time. The scoreboard 304 is configured to execute scoring of the attributes and maintaining of up-to-date record of the state information. More specifically, the scoreboard 304 is configured to compute the value and the confidence factor associated with accuracy of each attribute. As explained with reference to FIG. 2, the value may be embodied as a binary representation based value or a probability-based value. For example, value of attributes related to persona and presence information may be either confirmed in a binary form, such as “yes” and “no”, or probabilistically scored based on confidence factor. In an embodiment, the computation of value and the confidence factor is performed by a series of direct and indirect evidence/correlations to facts, parameters and/or other personas that are known and are already confirmed. An example of such a parameter is a time constant parameter, which determines how long retained information is relevant or fresh, after which the information needs to be refreshed. The scoring of the attributes (or determining the value and the confidence factor corresponding to the value) based on the time constant parameter may be performed as explained with reference to FIG. 2 and is not explained herein. In an embodiment, in addition to the state information, the scoreboard 304 is configured to actively focus on specific data items and specific personas as well as lookout for targeted presences and update corresponding information continuously through feedback learning thereby scoring each data item based on its impact on successful intent and action prediction and scoring each persona profile based on its importance, business value and frequency.

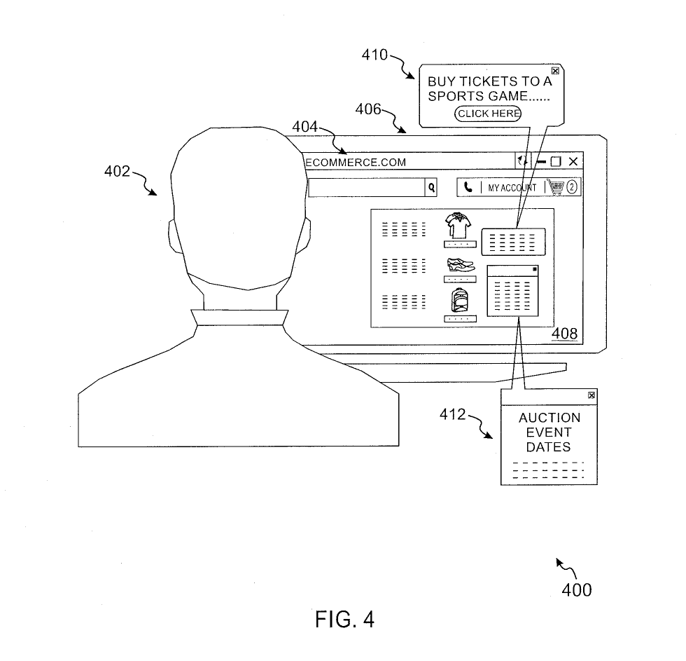

In an embodiment, the platform 302 is configured to provide support to the plurality of service layers in the multi-service layer 306. In an embodiment, the platform 302 may be embodied as a big data platform. The platform 302 is configured to maintain persistent record and continuously improve quantity, quality and confidence of persona profiles and associated data features with integrations available to enterprise client proprietary systems. In an embodiment, the platform 302 is configured to audit and catalog existing persona profiles and associated features and data for confidence, accuracy and completeness. Further, the key data features may be learned and prioritized by importance and relevance for their predictive impact. New persona data and features along with the presence of these personas may be captured and scored continually and consistently across all customer/enterprise channels of interactions, such as web, speech, native, mobile, social, agent, branch channels and the like. Further, the platform 302 is configured to instrument, report and learn from feedback learning and billing. Further, the platform 200 actively seeks to upgrade or expand the allowable uses, access and scope for the data catalog by continuously and creatively engaging customers to grant increasing permissions through a combination of personalized interactions, benefits presentations, influences and persuasions techniques. Furthermore, prediction and key actionable insights such as predicting consumer intent and journey, next best action, anticipated obstacles, best course of action, required pre-work, and the like may also be defined. Furthermore, unique personalized experiences matching to the specific customer's intent, needs and journey and that minimize customer effort and maximize ease of use and speed of completion may be created by the platform 302. Furthermore, specific actions and information may be delivered to the customer in the relevant channel and across all channels where a persona is present while delivering improved business results to the enterprise. In an embodiment, the platform 302, in conjunction with the control layer 322 is configured to execute a continuous process cycle involving the above steps to facilitate improvement of customer interaction experiences. The improvement of customer interaction experiences is further explained with reference to an illustrative example in FIG. 4.

Referring now to FIG. 4, a schematic representation 400 of an exemplary scenario is shown for illustrating a provisioning of personalized treatment to a customer 402 by the apparatus 200 of FIG. 2 based on correlation of a persona to a customer interaction in accordance with an embodiment. More specifically, the schematic representation 400 depicts the customer 402 accessing an e-commerce portal 404 on an electronic device 406 (exemplarily depicted to be a desktop computer) associated with the customer 402. The apparatus 200 may detect presence of the customer 402 in the web channel and moreover receive customer interaction data corresponding to the customer activity on the e-commerce portal 404 in an on-going manner. In an example scenario, the customer 402 may be accessing images related to sports merchandize on the e-commerce portal 404. The apparatus 200 is caused to compare the current customer activity with stored persona profiles corresponding to the customer 402 and detect the presence of ‘sports enthusiast’ persona associated with the customer 402. Accordingly, the presence of the sports enthusiast persona in the web channel may be identified and recorded as presence information. The apparatus 200 is caused to correlate the identified persona to the on-going customer interaction, or, more specifically interpret the on-going customer interaction based on the persona identified to be present.

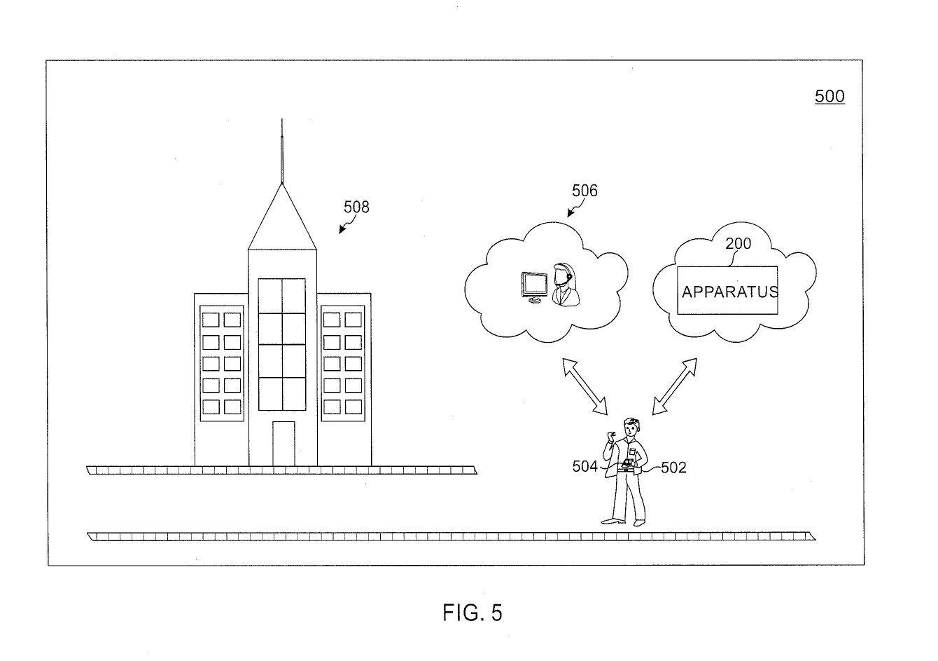

In an example scenario, the persona profile corresponding to the sports enthusiast persona may include information related to preferences, likely actions and likely needs of the customer 402 when inhabiting the sports enthusiast persona. For example, the customer 402 may be (1) fan of a particular soccer club and more so of a particular professional within the club (2) an avid collector of memorabilia related to baseball and (3) occasionally participating in golfing events. Such preferences of the customer 402 may be recorded in the persona profile corresponding to the sports enthusiast persona. Moreover, general preferences of the customer 402, such as an affinity to purchase apparel and shoes may also be included in the persona profile corresponding to the sports enthusiast persona. Further, likely actions of the customer 402, such as purchasing products related to sports pursued, buying tickets for a game etc. might also be a part of the persona profile corresponding to the sports enthusiast persona. The apparatus 200 may be caused to predict intent of the customer 402 based on the correlation of the customer interaction to the sports enthusiast persona. For example, the apparatus 200 may predict that the customer 402 may intend to purchase apparel. Accordingly, one or more types of apparel related to specific sports team or players preferred by the customer 402 or events participated by the customer 402 may be displayed to the customer 402 on display screen 408 of the electronic device 406. Further one or more clickable widgets, such as clickable widget 410 may be displayed inquiring if the customer 402 would like to purchase tickets to sports game of his/her favorite team to be held on the coming weekend. If the customer 402 is prone to seeking discounts or has preference for particular type of stadium seats then such information may be factored in, while displaying the clickable widget. Further, given customer's preference for collecting baseball related memorabilia, one or more informational pop-ups, such as pop-up 412, suggesting auction events for related items to be held in coming weeks may be displayed to the customer 402. Further, based on the customer's calendar information available to apparatus 200, the list of events may be prioritized and displayed to the customer 402. Given the presence of the sports enthusiast persona, the customer 402 may find such personalized treatment for his/her interaction experience to be extremely useful and the entire interaction experience to be enjoyable. The improvement of customer interaction experience is further demonstrated with reference to another illustrative example in FIG. 5.

Referring now to FIG. 5, another schematic representation 500 of an exemplary scenario is shown for illustrating a provisioning of personalized treatment to a customer 502 by the apparatus 200 of FIG. 2 in accordance with another embodiment. More specifically, the schematic representation 500 depicts the customer 502 accessing a fitness application on an electronic device 504 (exemplarily depicted to be a tablet) associated with the customer 502. Accordingly, the customer 502 is deemed to be present in the native channel. The customer 502 may also concurrently access or interact with websites showcasing healthy foods to consume for working professionals on the electronic device 504. Accordingly, the customer 502 is also deemed to be present in the web channel. The apparatus 200 may be caused to compare customer activity in the native channel and the web channel with persona profiles associated with the customer 502 and identify the presence of the ‘health conscious’ persona related to the customer 502. Based on the information stored in the persona profile associated with the health conscious persona of the customer 502, the apparatus 200 may be caused to provide one or more notifications to the customer 502 to provide personalized interaction experience to the customer 502.

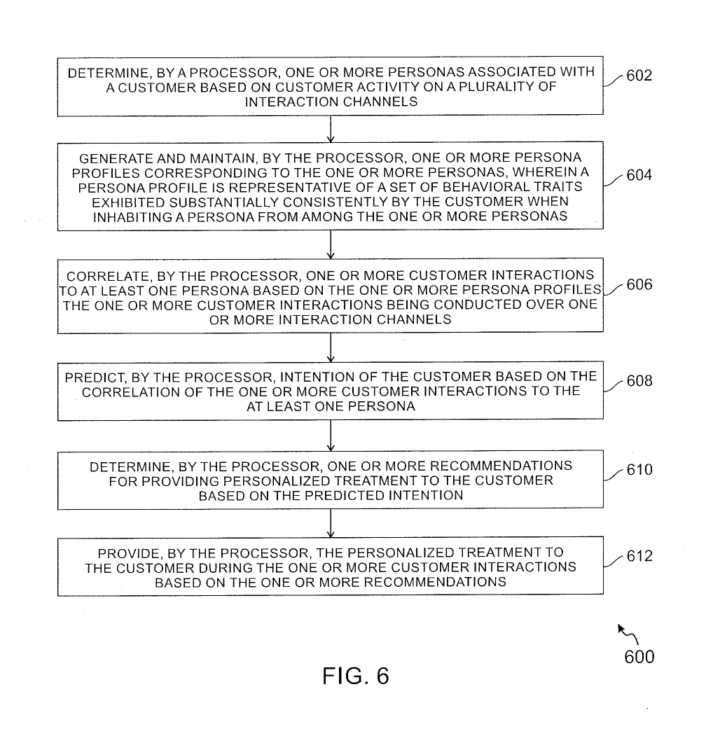

As explained with reference to FIG. 2, the apparatus 200 is caused to determine, in addition to presence information, attention information indicative of current attention of the customer 502. The apparatus 200 may then provide the one or more notifications to the customer 502 in the interaction channel in which the customer 502 is currently active or most likely to be active, based on the identified persona. If the determined attention information indicates that the customer 502 is currently active in the web channel, then the apparatus 200 is caused to provide the notification in the web channel as opposed to the native channel. Moreover, as explained with reference to FIG. 2, the notifications provided by the apparatus 200 are configured to be responsive to customer's preference for type of content, presentation of content, medium of interaction and the like, for an identified persona. In an embodiment, the apparatus 200 may be caused to provide a notification related to health insurance policy, which is due, to the customer 502. The notification may be embodied as an active notification or a passive notification as explained with reference to FIG. 2. For example, if the bill is due for next day, then the apparatus 200 may be caused to provide an active notification prompting customer action/response. However, if the bill is due next week, then the apparatus 200 may be caused to provide a passive notification informing the customer 502 of the bill payment due date. Further, the apparatus 200 may be caused to determine location information corresponding to the customer 502. Upon determining the location information and detecting that the customer 502 is on the street, the apparatus 502 may determine that, for the identified persona, the content of the active notification suggests that the customer 502 prefers a voice call rather than a chat. Accordingly, the active notification may include a request for initiating a call with a human agent, such as a live agent 506. The customer 502 may choose to approve or reject such a request. In an embodiment, the apparatus 200 may be caused to provide a link, which upon access may provide walking directions to an enterprise facility, such as the facility 508, near the customer's current location for facilitating bill payment on the insurance policy. In an embodiment, the apparatus 200 may be caused to provide notifications related to informational fitness tips, suggestions for eating healthy food nearby and the like. Without detecting the presence of the customer persona in the interaction channels, the apparatus 200 may be caused to provide notification as most conventional mechanisms do. More specifically, the conventional mechanisms are not configured to be responsive to a customer's preference for a type of content, a presentation of content, a notification medium, a time for receiving notification and the like. For example, in conventional mechanisms, a customer may receive notifications regarding weather forecasts, whereas the customer may prefer receiving notifications regarding news and sports related activities. In another illustrative example, the customer may receive a notification for an event of customer interest over email, whereas the customer may prefer receiving such notifications over phone. In some exemplary scenarios, the notifications may be sent to a customer at a time inconvenient for a customer to view the received notifications. For example, a notification regarding an offer on a product or a service may be sent to a customer when the customer is driving a vehicle or is engaged in an important professional activity and the customer may miss out on the notification. Notifications sent to customers in such a manner might fail to serve their intended purpose. Moreover, the customers may also miss out on important communication, which may negatively influence the customer's mood and even may result in adverse customer reaction towards the enterprise. Accordingly, by detecting the presence of the persona in an interaction channel and taking the customer's preference into account prior to sending notifications to the customers, the apparatus 200 is caused to provide an improved customer interaction experience to the customers, such as the customers 502. A method for providing improved customer interaction experience is explained with reference to FIG. 6.

FIG. 6 illustrates a flow diagram of a first example method 600 for improving customer interaction experiences in accordance with an example embodiment. The method 600 depicted in the flow diagram may be executed by, for example, the apparatus 200 explained with reference to FIGS. 2 to 5. Operations of the flow diagram, and combinations of operation in the flow diagram, may be implemented by, for example, hardware, firmware, a processor, circuitry and/or a different device associated with the execution of software that includes one or more computer program instructions. The operations of the method 600 are described herein with help of the apparatus 200. For example, one or more operations corresponding to the method 600 are explained herein to be executed by a processor, such as the processor 202 of the apparatus 200. It is noted that though the one or more operations are explained herein to be executed by the processor alone, it is understood that the processor is associated with a memory, such as the memory 204 of the apparatus 200, which is configured to store machine executable instructions for facilitating the execution of the one or more operations. It is also noted that, the operations of the method 600 can be described and/or practiced by using an apparatus other than the apparatus 200. The method 600 starts at operation 602.

At operation 602, one or more personas associated with a customer are determined by a processor (such as the processor 202 of apparatus 200 explained with reference to FIG. 2) based on customer activity on a plurality of interaction channels. As explained with reference to FIG. 1, customers may interact with an enterprise over multiple interaction channels. The information related to the customer activity on the interaction channels may be collated and stored as interaction data. For example, the customer may access a website corresponding to the enterprise for locating content of interest. Accordingly, information related to the customer activity on the website, such as sequence of web pages visited, menus accessed on one or more web pages, time spent on the web pages and such other information related to the customer's web journey may be stored as interaction data. It is understood that interaction data may further comprise data collated from customer activity on other interaction channels, such as speech channel, chat channel, social channel, native mobile application channel, enterprise branch channel (for example, customer's visit to a physical store) and the like. In addition to the interaction data, profile information corresponding to the customer is stored. Example types of information included in the stored profile information are explained with reference to FIG. 2 and are not included herein. In an embodiment, the interaction data and the profile information corresponding to the customer are analyzed to identify behavioral traits exhibited by the customer during various interaction scenarios and accordingly determine one or more personas associated with the customer. For example, the customer may assume a persona of a bargain shopper when at a discount store, whereas the same customer may assume a persona of a high net-worth individual when buying a suit at a premium clothing store. In another example scenario, a customer may exhibit markedly different risk preferences in their own accounts, such as accounts related to a retirement fund, a holiday savings fund and an education savings investment. In some example scenarios, the customer may exhibit different interaction styles even within interactions with the same enterprise based on different factors, such as the importance or severity of the issue or the nature or cost of a purchase or customer's mood, time pressure at the moment of interaction and the like. Accordingly, one or more such personas (for example, a bargain hunter, risk averse investor etc.) associated with the customer may be identified based on the customer activity on the interaction channels. More specifically, one or more such personas associated with the customer are identified based on extracting behavioral traits exhibited by the customer during the customer's activity on the plurality of interaction channels.

At operation 604, one or more persona profiles corresponding to the one or more personas are generated and maintained by the processor, where a persona profile is representative of a set of behavioral traits exhibited substantially consistently by the customer when inhabiting a persona. In an embodiment, the set of behavioral traits comprise behavioral traits related to at least one of customer preference, likely actions of the customer and likely needs of the customer. For example, a persona profile corresponding to the bargain hunter persona or self-service-preferred persona of the customer may be generated and maintained. The preferences, likely actions and likely needs of the customer when inhabiting the bargain hunter persona may be determined and stored as set of behavioral traits in the persona profile corresponding to the bargain hunter persona. The persona profiles corresponding to the multiple persona profiles may be maintained by the apparatus 200 to enable prediction of the most effective treatment for the customer while he/she is embodying the specific persona.

In an embodiment, one or more behavioral traits from among the set of behavioral traits are shared among the one or more personas. More specifically, certain preferences may be common across multiple persona profiles for a customer. For example, the customer may exhibit a preference for web channel or preference to use mobile phone, or even a preference/need for reassurance/confirmation during the course of the interaction. Such preferences may be common to customer's multiple persona profiles. Other preferences, however, such as risk tolerance or openness to types of offers may be applicable to a specific customer persona. For example, a customer's acceptance of offer to invest in emerging markets investment option may differ depending on whether the customer is accessing their primary investment fund or their child's college education fund. It is noted that each persona profile may be associated with multiple journeys (for example, possible courses of action during a customer interaction) and intents. In an embodiment, an aggregate profile corresponding to the customer may be generated based on the one or more persona profiles. More specifically, information related to the multiple persona profiles may be combined into an aggregate profile to develop a comprehensive view of the customer.

At operation 606, one or more customer interactions are correlated to at least one persona based on the one or more persona profiles, where the one or more customer interactions are conducted over one or more interaction channels from among the plurality of interaction channels. In an embodiment, in order to facilitate correlation of the one or more customer interactions to the at least one persona, a presence of the at least one persona in the one or more interaction channels is identified. The detection of the at least one persona in the one or more interaction channels may be performed as explained with reference to an illustrative example in FIG. 2 and is not explained again herein. Once the presence of the customer in an interaction channel is identified, then, the correlation of the corresponding customer interaction to a persona profile is performed based on the stored multiple persona profiles. More specifically, one or more behavioral traits exhibited by the customer in the current/on-going interaction may be identified and compared with sets of behavioral traits included within the multiple persona profiles to determine the presence of the persona in the interaction channel. The current/on-going customer interaction may thereafter be linked to the persona present therein to facilitate the said correlation. If the presence of the persona is detected in multiple interaction channels, then the concurrent or sequential customer interactions may be correlated to the same persona. In an embodiment, the presence of a persona in an interaction channel is stored as presence information. The presence information is subsequently tracked and updated (for example, by using the scoreboard 304 explained with reference to FIG. 3).

At operation 608, intention of the customer is predicted by the processor based on the said correlation of the one or more customer interactions to the at least one persona. The customer interaction and profile information may be subjected to a set of text mining & predictive models (explained with reference to FIG. 2 and not included herein) for mining relevant information that drive the prediction of the customer intent. At operation 610, one or more recommendations are determined by the processor for providing personalized treatment to the customer based on the predicted intent. At operation 612, the personalized treatment is provided to the customer by the processor during the one or more customer interactions based on the one or more recommendations. In an embodiment, the personalized treatment provided to the customer based on the one or more recommendations is configured to maximally reduce at least one of cognitive effort and activity effort for the customer for achieving the predicted intention. In an embodiment, location information (for example, geo-location data) corresponding to the customer is determined, where the location information facilitates said determination of the one or more recommendations. For example, if the customer invokes a native mobile application corresponding to best shopping deals indicating that the persona present in the native channel corresponds to the bargain shopper persona, and, moreover if the location information of customer indicates that the customer is in an enterprise store outlet (i.e. in branch channel), then an intent of the customer for being present in the store may be inferred and one or more recommendations to provide a more personalized treatment to the customer may be determined, such as for example, arranging the outlet supervisor to personally meet the customer and address his/her concerns, recommend related products in the store that the customer may be interested in and that may be bought at a discount and the like.

In an embodiment, providing personalized treatment involves lowering a degree of authentication required or avoiding repetition of actions already performed in concurrent or sequential interactions initiated by the customer subsequent to initiating the one or more customer interactions upon authentication of the customer on the one or more interaction channels. Such provisioning of personalized treatment is explained with reference to an illustrative example in FIG. 2 and is not explained herein.

In an embodiment, up-to-date state information corresponding to the customer is maintained. In an embodiment, the state information includes attributes indicative of status of the one or more personas, presence information related to detected presence of the one or more personas in the plurality of interaction channels, and predicted intentions for the customer. The maintenance of the state information is explained with reference to FIG. 2 and is not explained again herein.

In an embodiment, continuous scanning of the plurality of interaction channels is performed to retrieve real-time information related to at least one of the one or more personas, one or more new personas, the presence information related to the detected presence of the one or more personas and the predicted intentions corresponding to the one or more personas. In an embodiment, the retrieval of the said information is performed from at least one interaction channel. Further, the state information is updated based on the said information. In an embodiment, the retrieved information from the at least one channel and the updated state information are provided to one or more remaining interaction channels from among the plurality of interaction channels. More specifically, data corresponding to the persona, intent, presence and state information is pulled from, or pushed into, the plurality of interaction channels. In an embodiment, the retrieval of the information from the at least one channel and the provision of the retrieved information and the updated state information to the to one or more remaining interaction channels are performed based on pre-defined rules as explained with reference to FIG. 2.

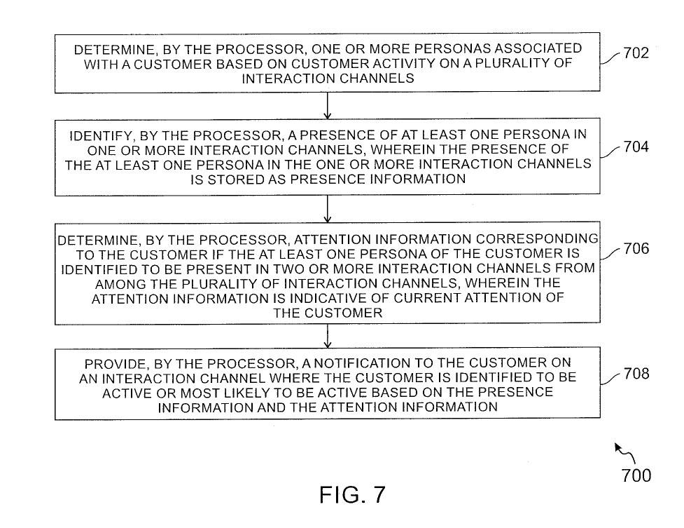

In an embodiment, attention information corresponding to the customer is determined if the customer is identified to be present in two or more interaction channels, where the attention information is indicative of a current attention of the customer. For example, even though the customer has logged in one or more social media accounts, the customer may be currently browsing a website, then the attention information is determined to be the web channel. In an embodiment, the presence information and the attention information corresponding to the customer are tracked and updated. In an embodiment, the identified persona, presence information and the attention information may be utilized to determine an interaction channel in which the customer is most active or most likely to be active. In an embodiment, a notification is provided to the customer on the interaction channel in which the customer is most active or most likely to be active based on the detected persona. The provisioning of notification for improving customer interaction experiences is further explained with reference to FIG. 7.

FIG. 7 illustrates a flow diagram of a second example method 700 for improving customer interaction experiences in accordance with an example embodiment. The method 700 depicted in the flow diagram may be executed by, for example, the apparatus 200 explained with reference to FIGS. 2 to 5. Operations of the flow diagram, and combinations of operation in the flow diagram, may be implemented by, for example, hardware, firmware, a processor, circuitry and/or a different device associated with the execution of software that includes one or more computer program instructions. The operations of the method 700 are described herein with help of the apparatus 200. For example, one or more operations corresponding to the method 700 are explained herein to be executed by a processor, such as the processor 202 of the apparatus 200. It is noted that though the one or more operations are explained herein to be executed by the processor alone, it is understood that the processor is associated with a memory, such as the memory 204 of the apparatus 200, which is configured to store machine executable instructions for facilitating the execution of the one or more operations. It is also noted that, the operations of the method 700 can be described and/or practiced by using an apparatus other than the apparatus 200. The method 700 starts at operation 702.

At operation 702, one or more personas associated with a customer are determined by a processor (such as the processor 202 of apparatus 200 explained with reference to FIG. 2) based on customer activity on a plurality of interaction channels. The determination of the one or more personas may be performed as explained with reference to operation 602 of the method 600 and is not explained herein. At operation 704, a presence of at least one persona from among the one or more personas is identified in one or more interaction channels from among the plurality of interaction channels by the processor, where the presence of the at least one persona in the one or more interaction channels is stored as presence information. At operation 706, attention information corresponding to the customer is determined by the processor if the at least one persona of the customer is identified to be present in two or more interaction channels, where the attention information is indicative of current attention of the customer. The identification of the presence of the at least one persona for determining presence information and the determination of the attention information may be performed as explained with reference to FIG. 6 and is not explained again herein.

At operation 708, a notification is provided to the customer by the processor on an interaction channel from among the plurality of interaction channels where the customer is identified to be active or most likely to be active based on the persona identified, presence information and the attention information. For example, upon determining that the customer is active on the social channel (for example, based on the determined presence and attention information), the notification is provided on the social networking media account of the customer. In an embodiment, the notification is configured to be responsive to at least one of customer's preference as indicated by the identified persona for a type of content, a presentation of the content, a medium of interaction (for example, device and/or interaction channel preference) and a time for receiving the said notification.

In an embodiment, the type and the content of notifications to be sent to the customer are determined based on the personal identification information, stored customer information and the inferred intent of the customer. For example, the notification is configured to be a passive notification or an active notification based on pre-determined criteria, where the passive notification is configured to provide useful information to the customer and, where the active notification is configured to prompt the customer to perform an action. For example, if the customer is to be notified of payment of a bill, then the type of notification may be configured to be a passive notification informing the customer of the bill due date. However, if the bill payment is due for next day, then the type of the notification may be configured to be an active notification prompting the customer to take immediate action. For example, the active notification may be configured to include a hyperlink which may direct the customer to a website for paying the bill. Alternatively, the active notification may be configured with clickable widget, which may direct the customer to an agent for enabling the customer to pay the bill. In another illustrative example, if it is inferred that the customer is interested in purchasing a product or availing a service, then an active notification may be configured for facilitating an interaction with an agent (for example, a chat interaction or a voice interaction with an IVR system or an agent) for enabling the customer to complete the purchase. The provision of active and passive notifications and further linking of concurrent and/or sequential interactions may be performed as explained with reference to FIG. 2 and is not explained again herein.

In addition to the type of notification, the apparatus 200 may be caused to configure the content of notifications to generate optimum response from the customer. For example, a notification corresponding to an attractive offer for a product or a service may be complimented with information, such as for example, pictures of friends of customers who also bought the product or availed the service, personal and professional information relating to customer such as for example birthdays, anniversaries, change in professional task's or environment and the like. Similarly, a current location information or the calendar information of the customer may be utilized for generating notification content that is relevant for the customer's current location and schedule.

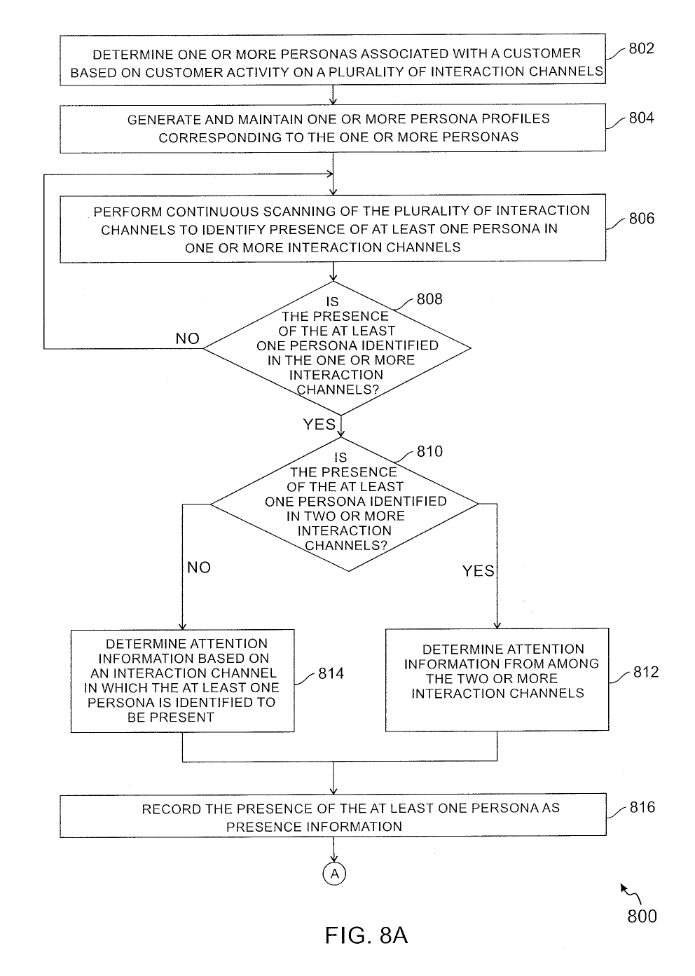

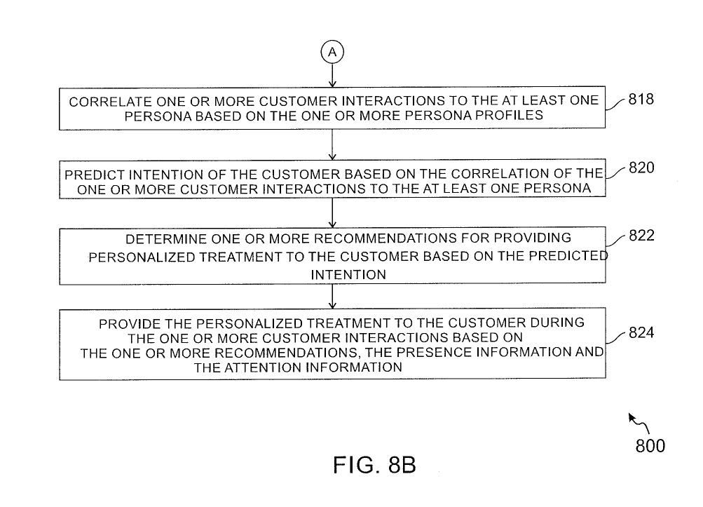

In an embodiment, a time duration for which the customer is expected to be attentive is predicted and thereafter the presentation of content to optimize a utilization of time duration for which the customer is predicted to be attentive may be configured. More specifically, a design of notification may be configured in a manner that optimizes a utilization of the time duration for which the customer is predicted to be attentive to the notification. Accordingly, a window size color, length of textual content, type of content (for example, video content, image content or textual content) and the like, may be optimally selected. Another method for improving customer interaction experience is explained with reference to FIGS. 8A and 8B.

FIGS. 8A and 8B illustrate a flow diagram of a third example method 800 for improving customer interaction experiences in accordance with an example embodiment. Operations of the flow diagram, and combinations of operation in the flow diagram, may be implemented by, for example, hardware, firmware, a processor, circuitry and/or a different device associated with the execution of software that includes one or more computer program instructions. The method 800 starts at operation 802.

At operation 802, one or more personas associated with a customer are determined based on customer activity on a plurality of interaction channels. At operation 804, one or more persona profiles corresponding to the one or more personas are generated and maintained, where a persona profile is representative of a set of behavioral traits exhibited substantially consistently by the customer when inhabiting a persona. The operations 802 and 804 are similar to the operations 602 and 604 explained with reference to method 600 in FIG. 6, respectively, and are not explained herein for sake of brevity. At operation 806, continuous scanning of the plurality of channels is performed to identify a presence of at least one persona from among the one or more personas in one or more interaction channels from among the plurality of interaction channels. The operation 806 is similar to operation 704 explained with reference to method 700 in FIG. 7 and is not explained herein. At operation 808, it is determined if the at least one persona is present in the one or more interaction channels. If it is determined that at least one persona was present in the one or more interaction channels at operation 808, then operation 810 is performed or else operation 806 is repeatedly performed till at least one persona is identified to be present in one or more interaction channels. At operation 810, it is determined if the at least one persona is present in two or more interaction channels. If it is determined that the at least one persona is present in two or more channels, then an attention information is determined at operation 812 from among the two or more interaction channels, where the attention information is indicative of the current attention (to a channel) of the customer. Thereafter, operation 816 is performed. If it is determined that the at least one persona is not present in two or more interaction channels, implying that the at least one persona is present in only one interaction channel, then at operation 814 the attention information corresponding to the customer is determined based on the only interaction channel in which the at least one persona is determined to be present. At operation 816, the presence of the at least one persona in the one or more interaction channels is recorded as presence information. At operation 818, one or more customer interactions are correlated to the at least one persona based on the one or more persona profiles. The correlation of the detected personas to the customer interactions may be performed as explained with reference to FIG. 2 and is not explained again herein. At operation 820, intention of the customer is predicted based on the said correlation of the one or more customer interactions to the at least one persona. At operation 822, one or more recommendations are determined for providing personalized treatment to the customer based on the predicted intent. The operations 820 and 822 are similar to the operations 608 and 610 explained with reference to method 600 in FIG. 6, respectively, and are not explained herein for sake of brevity. At operation 824, the personalized treatment is provided to the customer during the one or more customer interactions based on the one or more recommendations, the presence information and the attention information. The provisioning of the personalized treatment may be performed as explained with reference to FIG. 2. In an embodiment, the provisioning of the personalized treatment includes providing a notification to the customer on the interaction channel that the customer is active or most likely to be active based on the identified persona. The provisioning of notification may be performed as explained with reference to method 700 and is not explained again herein.

Without in any way limiting the scope, interpretation, or application of the claims appearing below, advantages of one or more of the exemplary embodiments disclosed herein include improving customer interaction experiences. Various embodiments disclosed herein provide numerous advantages for enhancing a customer service experience, thereby contributing to increased attributable revenue, increased resolution rates, increased efficiency, decreased cost of service and cost of sales, increased loyalty and retention, deepened relationship and increased live time value. The techniques disclosed herein uniquely suggest correlation of customer interactions to persona profiles as opposed to individuals, which has numerous advantages in customer intent prediction as well in provisioning of personalized treatment as explained above. Further, the suggested techniques also assist in collection of persona data and capturing additional valid data parameters and features associated with each persona profile. Furthermore, the scalable architecture of the apparatus 200 as disclosed in FIG. 3 facilitates in automatically and continuously capturing, validating, growing, and fine-tuning the usable persona database from disparate data feeds from different interaction channels and time events. Further, the present technology facilitates automatic identification of presence of personas and combining of the persona information, the intent prediction and the personalized action across channels in real-time to provide the easiest and quickest appropriate resolution for the issue. Further, techniques disclosed herein suggest notifying and/or interacting with customers in a medium where the customer is active or most likely to be active. Moreover, the interaction is conducted in a manner preferred by the customer and most suited to the content of the notification. Accordingly, apparatuses and methods disclosed herein take customer's preference into account prior to sending notifications to the customers. By taking the customer's preferences into account, the notifications have a far greater likelihood of serving their intended purpose. Moreover, by detecting customer presence and attention information, a likelihood of the customer missing out on important communication is also drastically reduced. The notifications and/or interactions conducted in such a manner may positively influence a customer's mood and even may result in favorable customer reaction to the product or service being referred to by the agent/IVR system. Accordingly a quality of customer sales and/or service experience may be improved providing benefits to both the customers and the enterprises.

Although the present technology has been described with reference to specific exemplary embodiments, it is noted that various modifications and changes may be made to these embodiments without departing from the broad spirit and scope of the present technology. For example, the various operations, blocks, etc., described herein may be enabled and operated using hardware circuitry (for example, complementary metal oxide semiconductor (CMOS) based logic circuitry), firmware, software and/or any combination of hardware, firmware, and/or software (for example, embodied in a machine-readable medium). For example, the apparatuses and methods may be embodied using transistors, logic gates, and electrical circuits (for example, application specific integrated circuit (ASIC) circuitry and/or in Digital Signal Processor (DSP) circuitry).

Particularly, the apparatus 200, the processor 202 and the memory 204 may be enabled using software and/or using transistors, logic gates, and electrical circuits (for example, integrated circuit circuitry such as ASIC circuitry). Various embodiments of the present technology may include one or more computer programs stored or otherwise embodied on a computer-readable medium, wherein the computer programs are configured to cause a processor or computer to perform one or more operations (for example, operations explained herein with reference to FIGS. 6, 7, 8A-8B). A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), DVD (Digital Versatile Disc), BD (Blu-ray (registered trademark) Disc), and semiconductor memories (such as mask ROM, PROM (programmable ROM), EPROM (erasable PROM), flash ROM, RAM (random access memory), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

Various embodiments of the present disclosure, as discussed above, may be practiced with steps and/or operations in a different order, and/or with hardware elements in configurations which are different than those which are disclosed. Therefore, although the technology has been described based upon these exemplary embodiments, it is noted that certain modifications, variations, and alternative constructions may be apparent and well within the spirit and scope of the technology.

Although various exemplary embodiments of the present technology are described herein in a language specific to structural features and/or methodological acts, the subject matter defined in the appended claims is not necessarily limited to the specific features or acts described above. Rather, the specific features and acts described above are disclosed as exemplary forms of implementing the claims.

1. A computer-implemented method, comprising:
determining, by a processor, one or more personas associated with a customer based on customer activity on a plurality of interaction channels;
generating and maintaining, by the processor, one or more persona profiles corresponding to the one or more personas, wherein a persona profile from among the one or more persona profiles represents a set of behavioral traits exhibited substantially consistently by the customer when inhabiting a persona from among the one or more personas;
correlating, by the processor, one or more customer interactions to at least one persona from among the one or more personas based on the one or more persona profiles, the one or more customer interactions being conducted over one or more interaction channels from among the plurality of interaction channels; and
predicting, by the processor, intention of the customer based on the correlation of the one or more customer interactions to the at least one persona.

2. The method of claim 1, further comprising:
identifying, by the processor, a presence of the at least one persona in the one or more interaction channels in connection with correlation of the one or more customer interactions to the at least one persona; and
storing the presence of the at least one persona in the one or more interaction channels as presence information.

3. The method of claim 1, further comprising:
maintaining, by the processor, up-to-date state information corresponding to the customer, wherein the state information comprises attributes indicative of status of the one or more personas, presence information related to detected presence of the one or more personas in the plurality of interaction channels, and predicted intentions related to the one or more personas.

4. The method of claim 3, further comprising:
associating each attribute from among the attributes with a value and a corresponding confidence factor, wherein the value comprises any of a binary representation based value and a probability based value.

5. The method of claim 4, further comprising:
associating the value with a time constant parameter indicative of an amount of time for which the value is relevant, and
revising the value or the corresponding confidence factor upon lapse of the amount of time.

6. The method of claim 3, further comprising:
performing, by the processor, continuous scanning of the plurality of interaction channels to retrieve real-time information related to at least one of the one or more personas, one or more new personas, the presence information related to the detected presence of the one or more personas, and the predicted intentions corresponding to the one or more personas, wherein the information is retrieved from at least one interaction channel from among the plurality of interaction channels;
updating, by the processor, the state information based on the information; and
providing, by the processor, the information and the updated state information to one or more remaining interaction channels from among the plurality of interaction channels.

7. The method of claim 6, further comprising:
performing the retrieval of the information from the at least one interaction channel and the provisioning of the information and the updated state information to the one or more remaining interaction channels based on pre-defined rules.

8. The method of claim 1, wherein the set of behavioral traits comprise behavioral traits related to at least one of customer preference, likely actions of the customer, and likely needs of the customer; and further comprising:
sharing one or more behavioral traits from among the set of behavioral traits among the one or more personas.

9. The method of claim 1, further comprising:
generating, by the processor, an aggregate profile corresponding to the customer based on the one or more persona profiles.

10. The method of claim 1, further comprising:
determining, by the processor, one or more recommendations for providing personalized treatment to the customer based on the predicted intention; and
providing, by the processor, the personalized treatment to the customer during the one or more customer interactions based on the one or more recommendations.

11. The method of claim 10, further comprising:
tracking and updating, by the processor, location information corresponding to the customer; and
using the location information to facilitate the determination of the one or more recommendations.

12. The method of claim 10, further comprising:
configuring the personalized treatment provided to the customer based on the one or more recommendations to maximally reduce at least one of cognitive effort and activity effort required from the customer to achieve the predicted intention.

13. The method of claim 1, further comprising:
any of lowering a degree of authentication required and avoiding repetition of actions already performed in concurrent or sequential interactions initiated by the customer subsequent to initiating the one or more customer interactions upon authentication of the customer on the one or more interaction channels.

14. The method of claim 2, further comprising:
determining, by the processor, attention information corresponding to the customer when the at least one persona of the customer is identified to be present in two or more interaction channels from among the plurality of interaction channels, wherein the attention information is indicative of current attention of the customer.

15. The method of claim 14, further comprising:
tracking and updating, by the processor, the presence information and the attention information corresponding to the customer;
determining, by the processor, an interaction channel from among the plurality of interaction channels on which the customer is active or most likely to be active based on the presence information and the attention information; and
providing, by the processor, a notification to the customer on the interaction channel.

16. The method of claim 15, further comprising:
configuring the notification to be responsive to customer's preference for any of a type of content, a presentation of the content, a medium of interaction, and a time for receiving the said notification.

17. The method of claim 16, further comprising:
configuring the presentation of the content to optimize use of time duration for which the customer is predicted to be attentive.

18. The method of claim 15, further comprising:
configuring the notification as any of a passive notification or an active notification based on pre-determined criteria;
configuring a passive notification to provide useful information to the customer; and
configuring an active notification to prompt the customer to perform an action.

19. The method of claim 18, wherein the active notification comprises a request for a natural language based interaction with a customer support representative.

20. A computer-implemented method, comprising:
determining, by a processor, one or more personas associated with a customer based on customer activity on a plurality of interaction channels;
identifying, by the processor, a presence of at least one persona from among the one or more personas in one or more interaction channels from among the plurality of interaction channels;
storing, by the processor, the presence of the at least one persona in the one or more interaction channels as presence information;
determining, by the processor, attention information corresponding to the customer when the at least one persona of the customer is identified to be present in two or more interaction channels from among the plurality of interaction channels, wherein the attention information is indicative of current attention of the customer; and
providing, by the processor, a notification to the customer on an interaction channel from among the plurality of interaction channels where the customer is identified to be active or most likely to be active based on the presence information and the attention information.

21. The method of claim 20, further comprising:
configuring the notification to be responsive to customer's preference for at least one of a type of content, a presentation of the content, a medium of interaction, and a time for receiving the said notification.

22. The method of claim 21, further comprising:
configuring the presentation of the content to optimize use of time duration for which the customer is predicted to be attentive.

23. The method of claim 21, further comprising:
configuring the notification as any of a passive notification or an active notification based on pre-determined criteria;
configuring a passive notification to provide useful information to the customer; and
configuring an active notification to prompt the customer to perform an action.

24. The method of claim 23, wherein the active notification comprises a request for a natural language based interaction with a customer support representative.

25. An apparatus, comprising:
at least one processor; and
a memory having stored therein machine executable instructions, that when executed by the at least one processor, cause the apparatus to:
determine one or more personas associated with a customer based on customer activity on a plurality of interaction channels;
generate and maintain one or more persona profiles corresponding to the one or more personas, wherein a persona profile from among the one or more persona profiles is representative of a set of behavioral traits exhibited substantially consistently by the customer when inhabiting a persona from among the one or more personas;
correlate one or more customer interactions to at least one persona from among the one or more personas based on the one or more persona profiles, the one or more customer interactions being conducted over one or more interaction channels from among the plurality of interaction channels; and
predict intention of the customer based on the correlation of the one or more customer interactions to the at least one persona.

26. The apparatus of claim 25, wherein the apparatus is further caused to:
identify a presence of the at least one persona in the one or more interaction channels for facilitating the correlation of the one or more customer interactions to the at least one persona; and
store the presence of the at least one persona in the one or more interaction channels as presence information.

27. The apparatus of claim 25, wherein the apparatus is further caused to:
maintain up-to-date state information corresponding to the customer, wherein the state information comprises attributes indicative of status of the one or more personas, presence information related to detected presence of the one or more personas in the plurality of interaction channels, and predicted intentions related to the one or more personas.

28. The apparatus of claim 27, wherein the apparatus is further caused to:
associate each attribute from among the attributes with a value and a corresponding confidence factor, wherein the value comprises any of a binary representation based value and a probability based value.

29. The apparatus of claim 28, wherein the apparatus is further caused to:
associate the value with a time constant parameter that is indicative of an amount of time for which the value is relevant; and
revise the value or the corresponding confidence factor upon lapse of the amount of time.

30. The apparatus of claim 27, wherein the apparatus is further caused to:
perform continuous scanning of the plurality of interaction channels to retrieve real-time information related to at least one of the one or more personas, one or more new personas, the presence information related to the detected presence of the one or more personas, and the predicted intentions corresponding to the one or more personas, wherein the said information is retrieved from at least one interaction channel from among the plurality of interaction channels;
update the state information based on the said information; and
provide the information and the updated state information to one or more remaining interaction channels from among the plurality of interaction channels.

31. The apparatus of claim 30, the apparatus is further caused to:
perform the retrieval of the information from the at least one interaction channel and the provisioning of the information and the updated state information to the one or more remaining interaction channels based on pre-defined rules.

32. The apparatus of claim 25, wherein the set of behavioral traits comprise behavioral traits related to at least one of customer preference, likely actions of the customer, and likely needs of the customer; and wherein the apparatus is further caused to:
share one or more behavioral traits from among the set of behavioral traits among the one or more personas.

33. The apparatus of claim 25, wherein the apparatus is further caused to:
generate an aggregate profile corresponding to the customer based on the one or more persona profiles.

34. The apparatus of claim 25, wherein the apparatus is further caused to:
determine one or more recommendations for providing personalized treatment to the customer based on the predicted intention; and
provide the personalized treatment to the customer during the one or more customer interactions based on the one or more recommendations.

35. The apparatus of claim 34, wherein the apparatus is further caused to:
track and update location information corresponding to the customer, to facilitate the determination of the one or more recommendations.

36. The apparatus of claim 34, wherein the apparatus is further caused to:
configure the personalized treatment provided to the customer based on the one or more recommendations to maximally reduce at least one of cognitive effort and activity effort required for the customer to achieve the predicted intention.

37. The apparatus of claim 25, wherein the apparatus is further caused to:
facilitate at least one of lowering a degree of authentication required and avoiding repetition of actions already performed in concurrent or sequential interactions initiated by the customer subsequent to initiating the one or more customer interactions upon authentication of the customer on the one or more interaction channels corresponding to the one or more customer interactions.

38. The apparatus of claim 26, wherein the apparatus is further caused to:
determine attention information corresponding to the customer when the at least one persona of the customer is identified to be present in two or more interaction channels from among the plurality of interaction channels, wherein the attention information is indicative of current attention of the customer.

39. The apparatus of claim 38, wherein the apparatus is further caused to:
track and update the presence information and the attention information corresponding to the customer;
determine an interaction channel from among the plurality of interaction channels on which the customer is active or most likely to be active based on the presence information and the attention information; and
provide a notification to the customer on the interaction channel.

40. The apparatus of claim 39, wherein the apparatus is further caused to:
configure the said notification to be responsive to customer's preference for at least one of a type of content, a presentation of the content, a medium of interaction, and a time for receiving the said notification.

41. The apparatus of claim 40, wherein the apparatus is further caused to:
configure the presentation of the content to optimize use of time duration for which the customer is predicted to be attentive.

42. The apparatus of claim 39, wherein the apparatus is further caused to:
configure the said notification as any of a passive notification and an active notification based on pre-determined criteria;
configure a passive notification is configured to provide useful information to the customer; and
configure an active notification is configured to prompt the customer to perform an action.

43. The apparatus of claim 42, wherein the active notification comprises a request for a natural language based interaction with a customer support representative.

44. A non-transitory computer-readable medium storing a set of instructions that when executed cause a computer to perform a method comprising:
determining one or more personas associated with a customer based on customer activity on a plurality of interaction channels;
generating and maintaining one or more persona profiles corresponding to the one or more personas, wherein a persona profile from among the one or more persona profiles is representative of a set of behavioral traits exhibited substantially consistently by the customer when inhabiting a persona from among the one or more personas;
correlating one or more customer interactions to at least one persona from among the one or more personas based on the one or more persona profiles, the one or more customer interactions being conducted over one or more interaction channels from among the plurality of interaction channels; and
predicting intention of the customer based on the correlation of the one or more customer interactions to the at least one persona.

45. The computer-readable medium of claim 44, further comprising:
identifying a presence of the at least one persona in the one or more interaction channels for facilitating the correlation of the one or more customer interactions to the at least one persona; and
storing the presence of the at least one persona in the one or more interaction channels as presence information.

46. The computer-readable medium of claim 44, further comprising:
maintaining up-to-date state information corresponding to the customer, wherein the state information comprises attributes indicative of status of the one or more personas, presence information related to detected presence of the one or more personas in the plurality of interaction channels, and predicted intentions related to the one or more personas.

47. The computer-readable medium of claim 46, further comprising:
associating each attribute from among the attributes with a value and a corresponding confidence factor, the value comprising any of a binary representation based value and a probability based value.

48. The computer-readable medium of claim 47, further comprising:
associating the value with a time constant parameter that is indicative of an amount of time for which the value is relevant; and
revising the value or the corresponding confidence factor upon lapse of the amount of time.

49. The computer-readable medium of claim 46, further comprising:
performing continuous scanning of the plurality of interaction channels to retrieve real-time information related to at least one of the one or more personas, one or more new personas, the presence information related to the detected presence of the one or more personas, and the predicted intentions corresponding to the one or more personas, wherein the said information is retrieved from at least one interaction channel from among the plurality of interaction channels;
updating the state information based on the information; and
providing the information and the updated state information to one or more remaining interaction channels from among the plurality of interaction channels.

50. The computer-readable medium of claim 49, further comprising:
performing the retrieval of the information from the at least one interaction channel and the provisioning of the information and the updated state information to the one or more remaining interaction channels based on pre-defined rules.

51. The computer-readable medium of claim 44, wherein the set of behavioral traits comprise behavioral traits related to at least one of customer preference, likely actions of the customer, and likely needs of the customer; and further comprising:
sharing one or more behavioral traits from among the set of behavioral traits among the one or more personas.

52. The computer-readable medium of claim 44, further comprising:
generating an aggregate profile corresponding to the customer based on the one or more persona profiles.

53. The computer-readable medium of claim 44, further comprising:
determining one or more recommendations for providing personalized treatment to the customer based on the predicted intention; and
providing the personalized treatment to the customer during the one or more customer interactions based on the one or more recommendations.

54. The computer-readable medium of claim 53, further comprising:
tracking and updating location information corresponding to the customer to facilitate the determination of the one or more recommendations.

55. The computer-readable medium of claim 53, further comprising:
configuring the personalized treatment provided to the customer based on the one or more recommendations to maximally reduce any of cognitive effort and activity effort required by the customer to achieve the predicted intention.

56. The computer-readable medium of claim 44, further comprising:
facilitating any of lowering a degree of authentication required and avoiding repetition of actions already performed in concurrent or sequential interactions initiated by the customer subsequent to initiating the one or more customer interactions upon authentication of the customer on the one or more interaction channels corresponding to the one or more customer interactions.

57. The computer-readable medium of claim 45, further comprising:
determining attention information corresponding to the customer when the at least one persona of the customer is identified to be present in two or more interaction channels from among the plurality of interaction channels, wherein the attention information is indicative of current attention of the customer.

58. The computer-readable medium of claim 57, further comprising:
tracking and updating the presence information and the attention information corresponding to the customer;
determining an interaction channel from among the plurality of interaction channels on which the customer is active or most likely to be active based on the presence information and the attention information; and
providing a notification to the customer on the interaction channel.

59. The computer-readable medium of claim 58, further comprising:
configuring the said notification to be responsive to customer's preference for at least one of a type of content, a presentation of the content, a medium of interaction, and a time for receiving the notification.

60. The computer-readable medium of claim 59, further comprising:
configuring the presentation of the content to optimize a time duration for which the customer is predicted to be attentive.

61. The computer-readable medium of claim 58, further comprising:
configuring the notification as any of a passive notification and an active notification based on pre-determined criteria;
configuring a passive notification to provide useful information to the customer; and
configuring an active notification to prompt the customer to perform an action.

62. The computer-readable medium of claim 61, wherein the active notification comprises a request for a natural language based interaction with a customer support representative.
